(19) United States
(12) Patent Application Publication
(10) Pub. No.: US 2026/0119595 A1
(43) Pub. Date: Apr. 30, 2026

(54) METHODS AND SYSTEMS FOR GENERATING MALLEABLE OVERVIEW-DETAIL USER INTERFACES

(71) Applicant: The Regents of the University of California, Oakland, CA (US)

(72) Inventors: Haijun Xia, San Diego, CA (US); Bryan Min, San Anselmo, CA (US); Yining Cao, San Diego, CA (US)

(21) Appl. No.: 19/376,807

(22) Filed: Oct. 31, 2025

Related U.S. Application Data
(60) Provisional application No. 63/714,730, filed on Oct. 31, 2024.

(51) Int. Cl. G06F 16/957; G06F 3/0482; G06F 3/04845

(52) U.S. Cl. CPC G06F 16/9577; G06F 3/0482; G06F 3/04845

(57) ABSTRACT

Methods and systems for generating malleable overview-detail user interfaces are described. An example method includes displaying, on the graphical user interface, a webpage comprising an overview view that corresponds to an initial ordering of multiple items and at least one detail view that corresponds to a selected item, and each item comprising multiple attributes. The method includes receiving a first input that toggles an attributes mode, and automatically identifying one or more attributes of the plurality of attributes on the graphical user interface. Then, the method includes receiving a second input that identifies a particular attribute from the one or more attributes, and modifying the graphical user interface to display the initial ordering of the plurality of items such that the particular attribute is displayed or hidden for each item in the overview view. An example system includes at least one processor configured to implement the above-described method.

### CROSS-REFERENCE TO RELATED APPLICATION

This patent document claims priority to and benefits of U.S. Provisional Patent Application No. 63/714,730 filed Oct. 31, 2024. The entire content of the before-mentioned patent application is incorporated by reference as part of the disclosure of this patent document.

### TECHNICAL FIELD

This patent document is generally related to user interfaces, and more particularly, to generating malleable overview-detail user interfaces.

### BACKGROUND

User interfaces (UIs) for tasks should be intuitive, user-friendly, and efficient. They must facilitate easy navigation, clear instructions, and quick access to essential functions. Effective UIs enhance productivity by minimizing user effort and reducing errors, ensuring a seamless interaction between the user and the system. Key elements include responsive design, which adapts to various devices and screen sizes, and accessibility features to accommodate users with disabilities. Additionally, incorporating feedback mechanisms, such as progress indicators and error messages, helps users stay informed and correct mistakes promptly. Overall, a well-designed UI significantly improves the user experience and task completion efficiency.

### SUMMARY

The overview-detail design pattern, characterized by an overview of multiple items and a detailed view of a selected item, is ubiquitously implemented across software interfaces. Designers often try to account for all users, but ultimately these interfaces settle on a single form. For instance, an overview map may display hotel prices but omit other user-desired attributes. To overcome these drawbacks, the disclosed embodiments provide malleable overview-detail interfaces that end-users can customize to address individual needs. The described content analysis of overview-detail interfaces uncovered three dimensions of variation: content, composition, and layout, enabling the development of customization techniques along these dimensions. For content, Fluid Attributes, a set of techniques enabling users to show and hide attributes between views and leverage AI to manipulate, reformat, and generate new attributes, were developed. For composition and layout, solutions to compose multiple overviews and detail views and transform between various overview and overview-detail layouts are provided. A user study on the described techniques implemented in two design probes revealed that participants produced diverse customizations and unique usage patterns, highlighting the need and broad applicability for malleable overview-detail interfaces.

In an example aspect, a method of interacting with a graphical user interface includes displaying, on the graphical user interface, a webpage comprising an overview view that corresponds to an initial ordering of a plurality of items and at least one detail view that corresponds to a selected item of the plurality of items, and where each item comprises a plurality of attributes. The example method further includes receiving, via the graphical user interface, a first input that toggles an attributes mode that enables modifying the graphical user interface, and automatically identifying, subsequent to receiving the first input, one or more of the plurality of attributes on the graphical user interface. Then, the example method includes receiving, via the graphical user interface, a second input that identifies a particular attribute from the one or more of the plurality of attributes, and modifying, based on the second input, the graphical user interface to display the initial ordering of the plurality of items such that the particular attribute is displayed or hidden for each item in the overview view.

In another example aspect, a system for using overview-detail interfaces includes a graphical user interface and at least one processor. In this system, the at least one processor is configured to display, on the graphical user interface, a webpage comprising an overview view that corresponds to an initial ordering of a plurality of items and at least one detail view that corresponds to a selected item of the plurality of items, and where each item comprises a plurality of attributes. The at least one processor is further configured to receive, via the graphical user interface, a first input that toggles an attributes mode that enables modifying the graphical user interface, and automatically identify, subsequent to receiving the first input, one or more of the plurality of attributes on the graphical user interface. Then, the at least one processor is configured to receive, via the graphical user interface, a second input that identifies a particular attribute from the one or more of the plurality of attributes, and modify, based on the second input, the graphical user interface to display the initial ordering of the plurality of items such that the particular attribute is displayed or hidden for each item in the overview view.

In yet another example aspect, an apparatus comprising a memory and a processor that implements the above-described methods is disclosed.

In yet another example aspect, the above-described methods may be embodied as processor-executable code and may be stored on a non-transitory computer-readable program medium.

The above and other aspects and features of the disclosed technology are described in greater detail in the drawings, the description and the claims.

### BRIEF DESCRIPTION OF THE DRAWINGS

FIGS. 1A and 1B illustrate an example of performing a content analysis of overview-detail interfaces, and providing a set of interactions for end-users to customize their overview-detail interface.

FIG. 2 illustrates example overview-detail UIs for Semantic Scholar and Airbnb.

FIGS. 3A and 3B illustrate an example design space of overview-detail interfaces on the web that include content, composition, and layout.

FIGS. 4A and 4B illustrate example variations in the content dimension.

FIGS. 5A-5C illustrate example variations in the composition dimension.

FIGS. 6A and 6B illustrate example variations in the layout dimension.

FIGS. 7A and 7B illustrate example interactions upon entering “Attributes Mode.”

FIG. 8 illustrates examples of additional prompts, provided by the user, to the AI to manipulate the attributes in the overview-detail interface.

FIG. 9 illustrates examples of generating new attributes with AI.

FIG. 10 illustrates an example of surfacing any attribute to the overview view.

FIGS. 11A and 11B illustrate example variations of the overview view.

FIG. 12 illustrates examples of user interactions with a malleable UI.

FIGS. 13A and 13B illustrate an example overview-detail UI for online shopping.

FIGS. 14A and 14B illustrate an example overview-detail UI for booking hotels.

FIG. 15 illustrates an example overview-detail UI for managing emails.

FIG. 16 illustrates an example overview-detail UI for reading live articles.

FIGS. 17A and 17B illustrate the flexibility of the disclosed embodiments across platforms such as mobile devices.

FIG. 18 illustrates a system diagram of malleable overview-detail interfaces.

FIG. 19 illustrates example results of participants'responses to the utility and usability of interactions to customize certain websites.

FIG. 20 illustrates example results of the number of customization operations made by each participant for each dimension.

FIG. 21 illustrates example logs of customizations made by participants.

FIGS. 22A and 22B illustrate example result of attribute visualization.

FIG. 23 is a flowchart illustrating an example method for interacting with a malleable overview-detail graphical user interface.

FIG. 24 is a block diagram illustrating an example system configured to implement one or more embodiments of the disclosed technology.

### DETAILED DESCRIPTION

Methods and systems directed to generating malleable overview-detail user interfaces are described. Overview-detail interfaces—commonly found in systems ranging from e-commerce sites to email platforms—can be made far more flexible and user-centric through malleability. One of the aspects of the disclosed technology is the concept of fluid attributes, an interaction technique that lets users surface, hide, sort, or filter any attribute from the detail view directly into the overview. With fluid attributes, users can also leverage AI tools to automate attribute creation and customization, generate new analytic attributes, and format inconsistent data, directly unifying user workflows. This approach enables dynamic reconfiguration of information displays, empowering end-users to better match the interface to their decision-making needs and information foraging style—significantly reducing time spent on context switching and manual navigation.

The described embodiments leverage three primary dimensions of overview-detail interface design: content (the specific attributes displayed within overview/detail), composition (how different overviews and details are interconnected and managed), and layout (the spatial organization of interface elements). The disclosed technology markedly improves upon existing systems, most of which offer only developer-determined, static, or limited customizability—often lacking support for user-driven changes in attribute visibility, organization, or layout. Some embodiments provide robust controls over all three dimensions, including the ability to create multiple synchronized overviews, generate new summary visualizations, and implement tabbed or dropdown layouts, thereby providing users the power to adapt interfaces for complex tasks and workflows, representing a significant leap in both usability and personalization compared to conventional overview-detail systems.

Section headings are used in the present document to improve readability of the description and do not in any way limit the discussion or the embodiments (and/or implementations) to the respective sections only.

### 1 Introduction

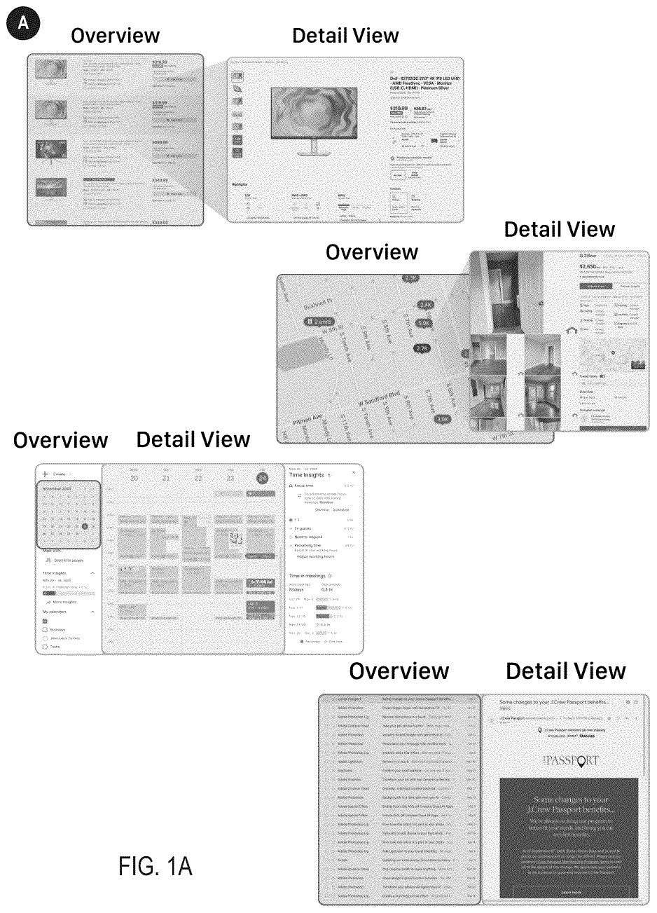

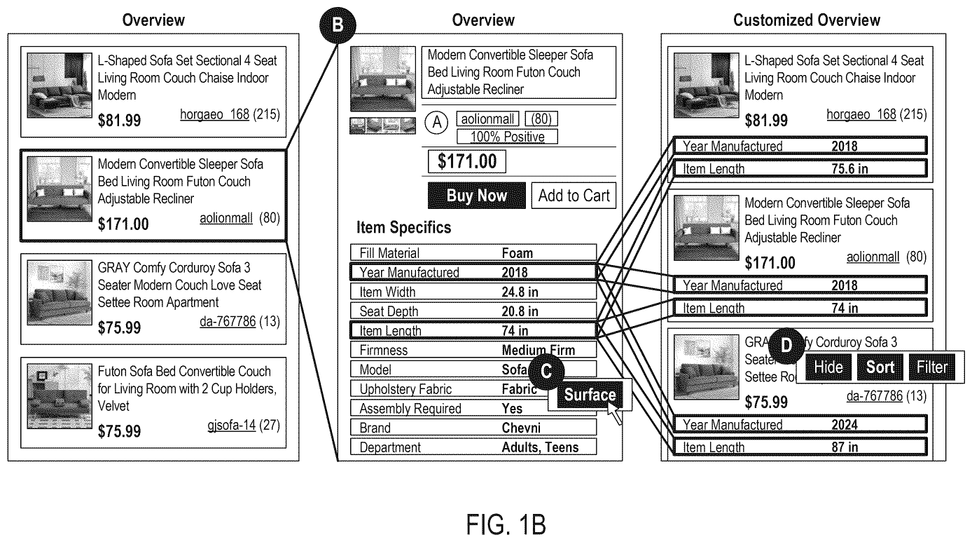

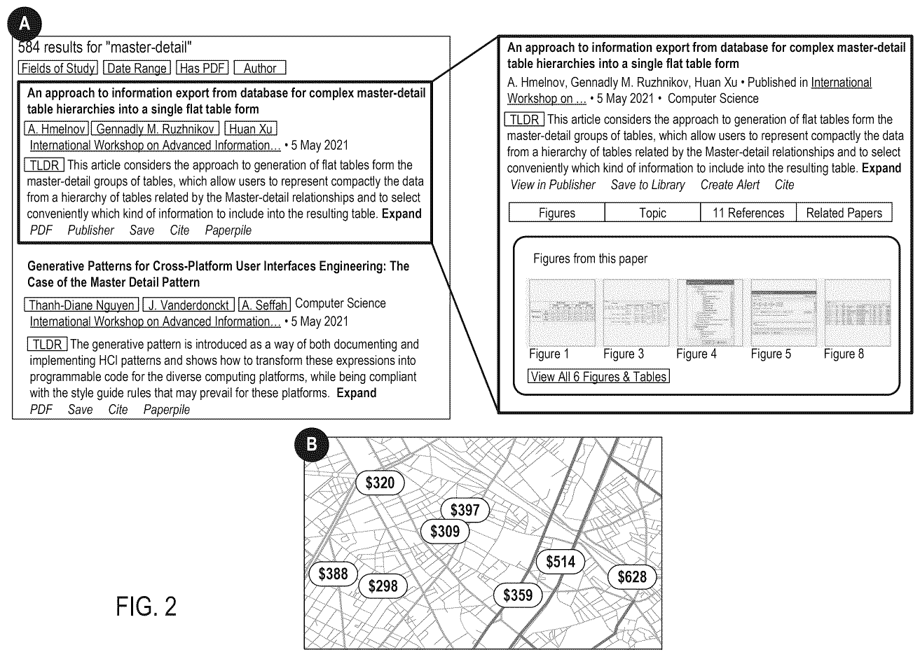

The overview-detail design pattern describes interfaces that typically consist of two views: an overview that presents a collection of items along with their key attributes and a detail view that provides an in-depth look at a selected item, including many, if not all, of its attributes. This pattern, examples of which are illustrated in FIG. 1A, enables users to efficiently browse through a large collection of items and delve into specific ones of interest, facilitating one of the most essential operations in information tasks. This is perhaps why the overview-detail pattern has become ubiquitous throughout information systems, including shopping, booking, and rental sites, calendars, email clients, and numerous others.

Typically, it is the designers and developers that determine how the overview-detail pattern is instantiated for a specific context, considering factors such as the layout and interaction between the overview and the detail view, as well as the different sets of attributes to present in these views. While they strive to create the best design for their general user base, a single instantiation of the overview-detail pattern is inevitably not enough to match the diverse needs of all users and their usage contexts. For instance, separating the detail view to another page, such as in most shopping websites, can reduce clutter in the interface but incur repetitive view switching (FIG. 2, A). Meanwhile, displaying only the price of hotels on a map improves clarity but omits other attributes—such as ratings or the number of beds—that some users may prioritize (FIG. 2, B). Yet, few modern interfaces are malleable, forcing the end-users to work with an interface set by their developers, regardless of the end-users' own needs and preferences.

At its core, the overview-detail design pattern is intertwined with fundamental challenges in information foraging, sense-making, and decision-making. First, the overview may not present the right abstraction of individual information entities to meet users' specific needs, forcing them to forage for details from other views. Second, a system may hinder sense-making if the representation of the collection of items it provides does not adequately address users' needs. Third, the spatial arrangement and interaction between multiple views may hinder necessary navigation among the different views. Therefore, one of the key questions addressed by the disclosed embodiments is: instead of letting developers dictate how information is abstracted and presented, can the overview-detail design pattern be made malleable? That is, can end-users be empowered to flexibly customize overview-detail interfaces to form their own abstractions and spatial arrangements of information? In particular, the following three aspects are considered:
(1) What is the design space of various implementations of this design pattern in real-world contexts, and how can they inform the development of malleable overview-detail interfaces?
(2) What are the interface designs and interaction techniques that can enable end-users to flexibly transform an overview-detail interface?
(3) To what extent do end-users prefer and utilize malleable overview-detail interfaces to achieve their information tasks? What are their novel usage patterns? Is the malleability we provide enough?

The following steps were taken to address these aspects. First, a content analysis was conducted with a diverse sample of 303 instantiations of the overview-detail pattern and identified three key dimensions: content, composition, and layout. Second, interaction techniques were developed that allow users to customize overview-detail interfaces along these three dimensions. For the content dimension, a set of interactions, which we label as Fluid Attributes, was developed, and which enables users to surface new attributes from the detail view to the overview (FIG. 1B, C), hide unwanted attributes in the overview, and use any selected attribute to filter and sort items (FIG. 1B, D). Users can also prompt AI to perform these customizations automatically, reformat existing attributes, and create new ones. For the composition and layout dimensions, we developed various options for end-users to select, such as setting the number of overviews in the interface and selecting layout options. We demonstrate how our presented customizations could be designed and implemented through multiple applications.

The efficacy of the disclosed technology is evinced through a user study (N=12) to measure the utility and observe usage patterns of malleable overview-detail interfaces using two design probes in shopping and hotel booking tasks. We found that participants, given the same tasks, desired and produced diverse customizations along all three dimensions. Furthermore, participants' usage patterns resembled common tendencies in managing personal digital information and structuring tasks, demonstrating how malleable overview-detail interfaces integrate into broader, everyday workflows.

Embodiments of the disclosed technology, amongst other benefits, provides:
(1) A content analysis of the overview-detail design pattern that reveals three key dimensions of the design space.
(2) Interaction techniques enabling end-users to customize overview-detail interfaces, offering diverse layouts and compositions of overviews and detail views, attribute manipulability across views, and AI-driven customizations.
(3) A user study demonstrating that participants effectively utilized malleable overview-detail interfaces to address diverse needs and revealing emergent usage patterns that inform design suggestions for future implementations.

### 2 Examples of Overview-Detail and Customizable UIs

### 2.1The Overview-Detail Design Pattern

The overview-detail design pattern describes interfaces that provide two views: an overview that contains a collection of items and a detail view that provides full details of a selected item. This pattern, also referred to as “master-detail” and “director-detail”, visualizes information for users to view a large collection of items first before uncovering their details. If overview-detail interfaces are designed with progressive disclosure in mind, they can offer a more approachable interface while still allowing users to access additional details.

Prior research explored several variations of the overview-detail pattern in user interfaces. Case studies have explored how overview-detail interfaces can be nested to create hierarchical views, how several detail views can be used simultaneously, and how different screen sizes may necessitate varying arrangements of the overview and detail views. Some researchers have explored how overviews and detail views can be arranged horizontally, vertically, and even along the “z-plane” by layering nested overviews and detail views along the z-axis, navigable by zooming. This z-axis arrangement also describes the structure of zoomable user interfaces such as Pad++. A relevant but distinct design pattern also explored is the “focus+context” interface, where focused content is placed seamlessly with the rest, oftentimes by reducing the view of the context space by scaling down items, skewing the views in 3D, and reducing the display's resolution.

These works demonstrate the diverse implementations of the overview-detail design pattern that researchers have developed, resulting in unique design choices tailored to specific contexts. However, the disclosed embodiments provide designs that enable users to flexibly customize the overview-detail interface according to their individual needs.

### 2.2Need for Malleable Overview-Detail Interfaces in Information Tasks

Many information tasks, such as foraging, sensemaking, and decision-making, involve an iterative process of searching, browsing, collecting information across various sources, making sense of collected information through various representations, and collecting new information based on new insights. Throughout this process, users need representations that help them effectively organize and preview a large number of information entities and quickly determine relevant ones by inspecting their details. The overview-detail pattern directly responds to such needs and, therefore, is ubiquitous in information systems, including information visualization systems and academic literature review tools.

As mentioned earlier, a single instantiation determined by developers is not enough. Therefore, many research systems that have been created to support information tasks are essentially providing additional overview-detail instantiations to compensate what could not be supported with existing ones. For example, prior work has explored comparison tables as a means to better organize decision-making criteria, hierarchical organizations of collected snippets to facilitate information management and re-finding, spatial canvases that scaffold the user's search and synthesis processes, and node-link diagrams to contextualize users with their past browsing activities.

Another line of work, recognizing that a single instantiation is not enough, proposes providing multiple instantiations, such as those that enable multiple levels of details or transforming information representations. Pad++ introduced semantic zooming, which offers multiple levels of detail based on different zoom levels, providing an alternative to geometric scaling techniques used in traditional zoomable interfaces. Recent research has also built on this idea to generate these different levels of detail with AI. Victor similarly illustrated multiple representations through the ladder of abstraction, demonstrating how users can move between representations of various details to gain a more comprehensive understanding of a system. WritLarge, on the other hand, demonstrated techniques for moving between multiple axes of representation—semantic, structural, and temporal—on a digital whiteboard. Graphologue also explored multiple representations, generating both text and node-link diagrams from an LLM in real-time to facilitate information comprehension. Similar to these systems, the disclosed technology provides multiple representations by providing end-users the ability to transform between different variations of overview-detail interfaces.

### 2.3Designing End-User Customizable Information Systems

The research community has had a long-standing vision of creating malleable information systems for end-users to easily and expressively customize them to suit their preferences and information needs. One research theme explores how to design the architecture of information systems to make them inherently customizable. For example, Haystack proposed a unified data model and a customizable interface layer to enable users to integrate diverse information sources and customize what information is presented to enable personalized information management. Smalltalk focused on enabling users to directly modify the appearance and behavior of any object in the GUI. HyperCard explored enabling users to create dynamic and interactive content through a scripting language and graphical user interfaces. Finally, Webstrates treated web documents as dynamic media, enabling users to create custom representations of the same DOM element while facilitating real-time, dynamic collaboration.

Another line of work explores the extension of existing systems to make them end-user customizable, particularly with web systems thanks to their accessible DOMs. For instance, research has explored enabling end-users to directly customize a web interface by modifying the CSS attributes for website prototyping, embedding annotations between DOM elements to facilitate in-situ note-taking, and filtering, sorting, and making spreadsheet computations to personalize lists of items shown on a webpage. Research has also explored the potential of web mashups and automations enabled by direct manipulation and programming-by-demonstration techniques to automate workflows and reduce context-switching.

Most of the above work, however, focus on exploring the underlying information architecture or the technical approach to enable customization for specific activities, applications, and platforms, rather than concretely and conceptually scoping how broadly generalizable their customizations are. For example, it is not readily obvious how approaches taken by personal information management systems (e.g., Haystack, Notion) should be generalized to shopping websites. Moreover, it is unclear how systems like Sifter, which recognize a common DOM structure for list views, can generalize to other list variations or even extend to different DOM structures. In contrast, embodiments of the disclosed technology provide an overview-detail design pattern that is ubiquitous across diverse information systems and platforms. The design space of the described overview-detail pattern allows interface designers to easily recognize the variations of overview-detail interfaces that exist in the wild and also serve as a comprehensive guide of what all the possible customizations any overview-detail interface variation could theoretically support.

### 2.4Manipulable Attributes in Software Interfaces

Extensive research has explored how manipulable attributes can be utilized in a variety of domains. First, data visualization focuses on encoding data into visuals, and manipulating data attributes has been a core technique that enables users to create, customize, and interact with data visualizations. Researchers have also used manipulable attributes to support creative tasks, enabling users to compose new graphical styles, search for related graphical objects based on attributes, and make color attributes manipulable across multiple representations. Personal information management systems such as Haystack have enabled users to manipulate attributes to modify how their personal information is presented, and database-and table-oriented software such as MS Access, Filemaker Pro, Notion, and Airtable have also allowed the end-user to show and hide attributes on their interface. Additionally, the content analysis of overview-detail interfaces has found e-commerce sites that allow end-users to show or hide a fixed set of attributes (Section 3.3).

The disclosed technology interprets the overview view and the detail view as two different containers of different sets of attributes, and by making both the attributes and views accessible and manipulable, end-users can be enabled to flexibly customize them. The described formulation of the malleable overview-detail design pattern acts as an amplifier, allowing attributes to be made manipulable for the overview-detail pattern and making them generalizable beyond each of their originally intended scenarios and contexts. Additionally, in some embodiments, AI is leveraged to facilitate end-users in manipulating attributes within the overview-detail interface to achieve their diverse information needs, enabling users to prompt the interface to surface, hide, sort by, filter by, and select values in attributes.

### 3 Examples of Content Analysis

To better understand the various implementations of the overview-detail design pattern, a content analysis of overview-detail interfaces in desktop websites was conducted. The content analysis was driven by the following questions:
[Q1] What kinds of overview-detail interface arrangements exist in the wild?
[Q2] What types of information are presented in the overview and detail view, respectively?
[Q3] What aspects of overview-detail interfaces, if any, are already customizable by end-users?

The findings are presented with a design space of three dimensions of variations in overview-detail interfaces (Q1, Q2) and report existing customizability options found in our collection (Q3).

### 3.1 Methodology

Data Collection. The goal of data collection was to collect a diverse and representative set of overview-detail interfaces that people regularly use. We initially collected the top 50 highest traffic websites in the United States based on data reported by a web analytics platform. However, as we analyzed this collection, we realized that many common websites were not included, such as flight booking or restaurant websites. To diversify our collection, we expanded to three more sources: (1) top 5 highest traffic websites in each of 33 web service categories identified by another web analytics platform, (2) 20 randomly sampled websites from Wordpress' showcase page to observe non-corporate websites such as blogs, and (3) 20 randomly sampled websites from Awwwards' gallery of “2024 Sites of the Year” to observe favorite designs from the UI/UX design community. After filtering the list (e.g., removing duplicates), the final sample consisted of 156 websites, which were all examined, and 303 instances of overview-detail interfaces were identified. Some websites featured multiple overviews linked to one detail view, or vice versa. For coding purposes, we defined each instance as a single overview-to-detail relationship. Thus, interfaces with multiple connections were recorded as separate instances.

Coding Procedure. A codebook of overview-detail interfaces was collaboratively developed through an iterative open coding process. In the first round of open coding, 20 overview-detail instances were randomly selected from the dataset of 303, and all 20 instances were individually analyzed. Their categories were clustered to develop an initial codebook. In the next round, a second sample of 20 instances were independently coded, achieving an inter-rater reliability of 94.8% agreement between the codes, measured by Cohen's kappa. Remaining differences were discussed and the dimensions were revised to reach a consensus. This process was repeated four times, stopping when no new dimensions or variations were found in the last three stages. In total, 120 overview-detail instances were analyzed.

### 3.2 Design Space

In some embodiments, the design space covers the following three dimensions:
Content describes whether the information is presented in the overview, the detail view, or both, and how the attributes in the overview are abstracted from those in the detail view.
Composition describes how multiple overviews and detail views are connected together.
Layout describes the spatial arrangement of overview and detail views within the interface.

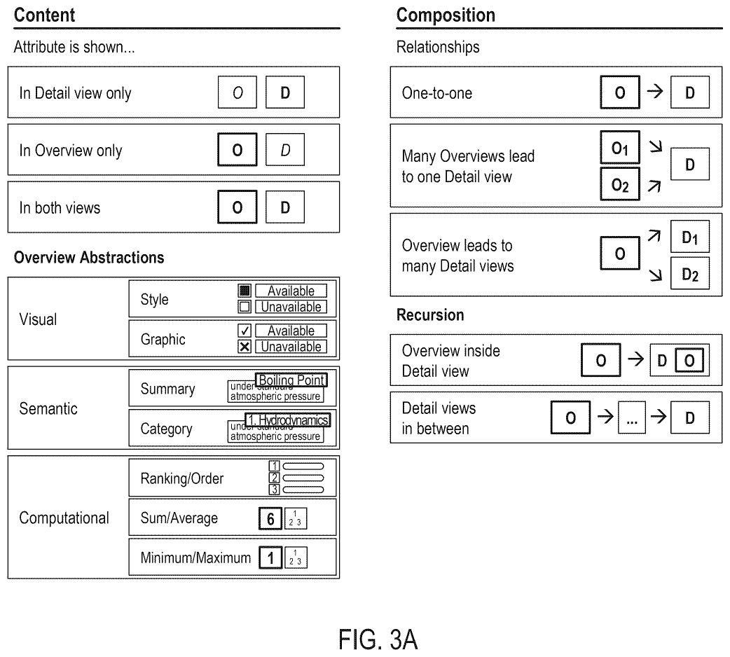

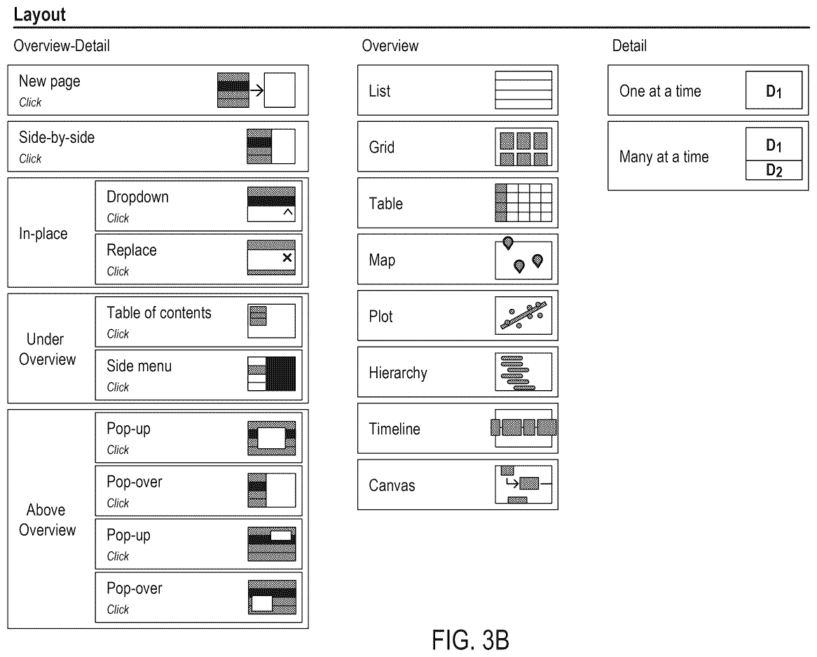

Notable cases found in these three dimensions are discussed below, and the full design space in presented in FIG. 3A and FIG. 3B.

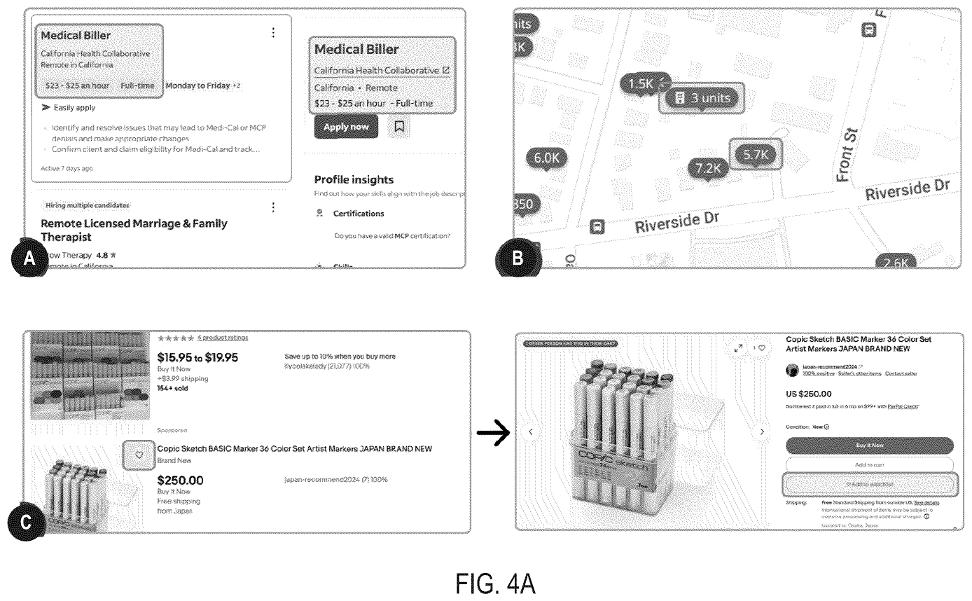

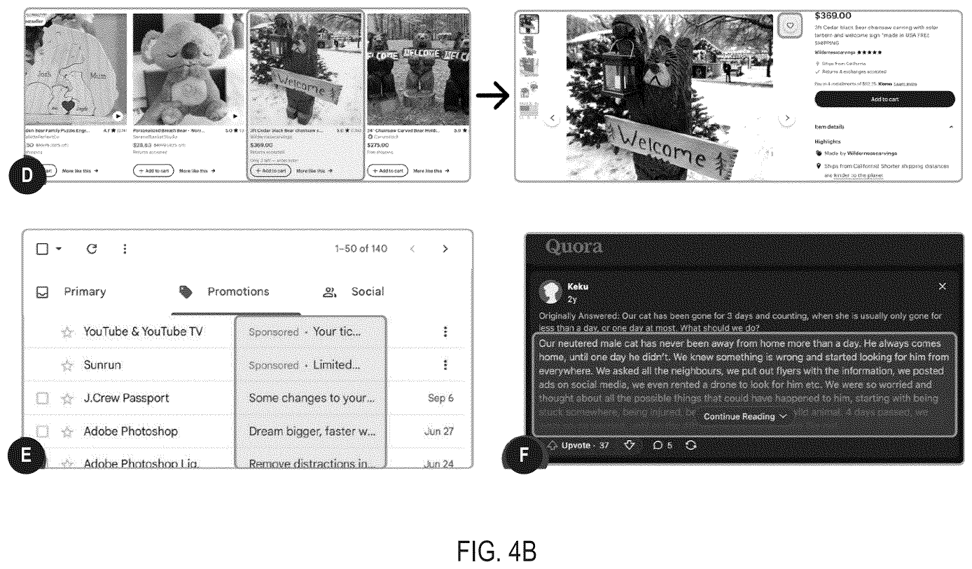

Content. Throughout the content analysis, it was observed that some attributes were displayed only in the overview, some were displayed only in the detail view, and some were displayed in both. For example, the search results page for job openings on Indeed showed job titles, company names, and salary ranges in both views, while the overview omitted attributes like qualifications and benefits (FIG. 4A, A). Although we initially coded attributes as static information elements, we also observed this pattern in interactive elements such as ‘Save’ buttons, text fields, and menus, with some sites including them in both the overview and detail views (FIG. 4A, C), while others displaying them only in the detail view (FIG. 4B, D). Moving forward, we considered interactive elements to be attributes as well. We also found that most rental and housing platform overviews presented prices for each place as pins on a map, but in Zillow, if a place had more than one unit available, the pin displayed the number of units available instead (FIG. 4A, B). In text-heavy overview-detail interfaces such as messaging apps and online discussion forums, we noticed long blocks of text in the overview were either cut short via ellipses (FIG. 4B, E) or a fade-out gradient (FIG. 4B, F).

It was further observed that some attributes in the overview served as an abstraction of information in the detail view, subsequently identifying three forms. First, visual abstractions, which were encoded into the style and visuals of the item, were found. For instance, Ticketmaster used color shading to indicate the number of seats available per section, with sections that had more seats shown in a saturated blue, while sections with fewer seats appeared in lighter shades. Second, semantic abstractions that represented the contents in the detail view with summaries or categories were found. For instance, ChatGPT's conversation interface generated a title that represented each conversation. Lastly, computational abstractions that computed attributes from the detail view into a value were found. For instance, Southwest's website presents a calendar view of the cheapest flight prices for each day.

Composition. Additionally, several overview-detail interfaces where multiple instances were composed together were identified.

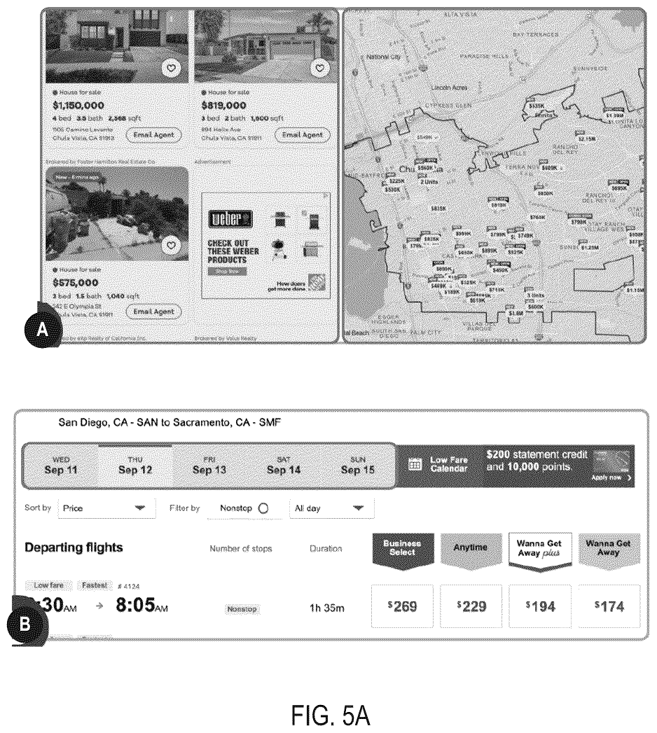

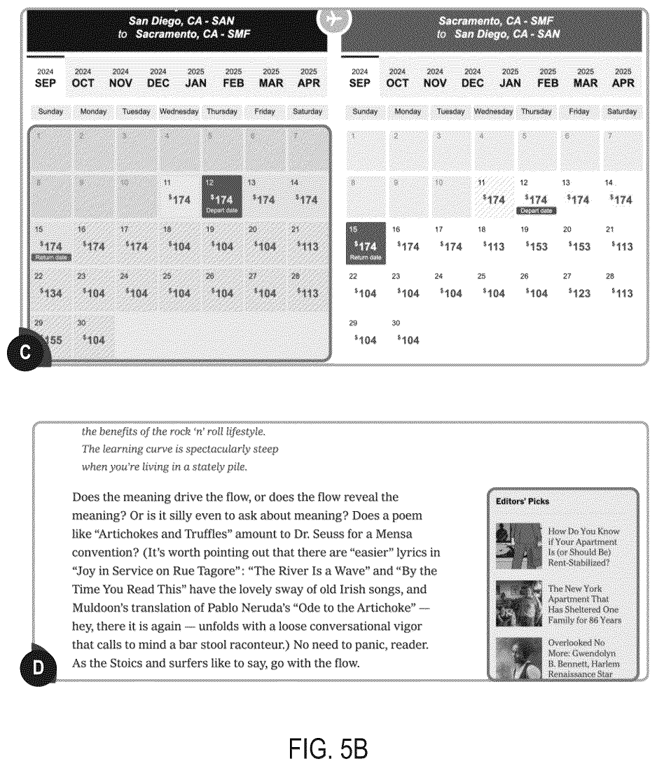

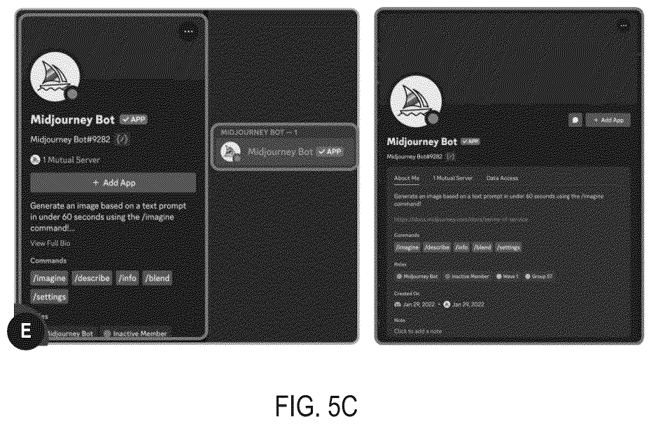

First, overview-detail relationships beyond just one-to-one were found. Many-to-one relationships presented multiple overviews such as a list overview and a map overview presented side-by-side (FIG. 5A, A), as well as different scopes such as a five-day list (FIG. 5A, B) and a 30-day calendar (FIG. 5B, C). Instances that synchronized navigation across the multiple overviews, where selecting an item in one overview would navigate users to the corresponding item in the other, were also found.

Second, instances of recursion—overview-detail interfaces nested within each other were found. For instance, additional overviews such as a list of articles appeared in the detail view of New York Times (FIG. 5B, D). This finding aligns with prior research that recognizes the variation of nested overview-detail views in hierarchical menu interfaces. Cases of “intermediate” detail views, in which a link or button inside one detail view opened another detail view containing more or all attributes of the item, were also observed. For instance, clicking on a user in a Discord server's list of users opened a tooltip profile card, and clicking on the profile picture in the tooltip opened a full-screen popup, revealing further details about mutual friends and servers (FIG. 5C, E).

Layout. Variations in the arrangement of overview views and detail views, the organization of items within overview views, and the number of items displayed in detail views were observed.

Overview-Detail: First, variations in the layout of overviews and detail views, where some websites arranged overviews and detail views side by side, while others opened detail views in a pop up or a dropdown, were observed.

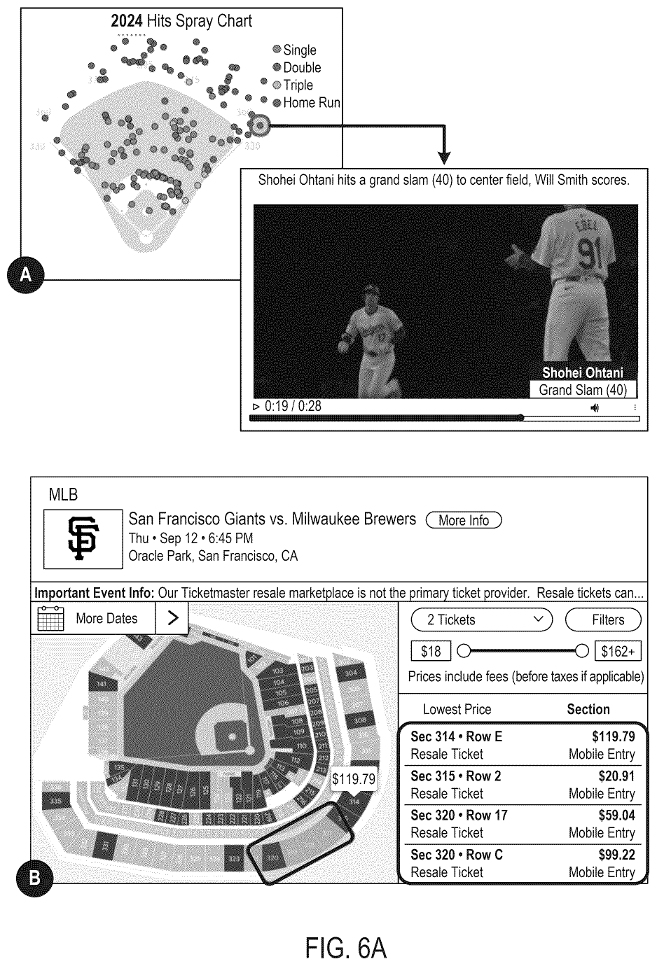

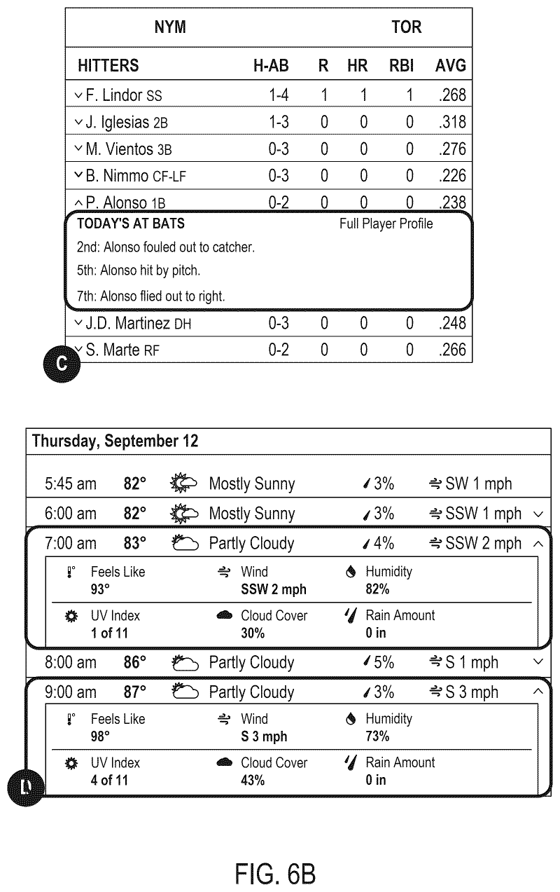

Overview: Variations of overview layout in the forms of lists, grids, and tables were also observed. Notable variations included visualizations that plotted points that could be opened into detail (FIG. 6A, A) and sports stadiums to select seating sections (FIG. 6A, B).

Detail: It was observed that detail views varied by how many were displayed at a time. Some instances only opened one detail view at a time, while others allowed users to open many at a time. For instance, ESPN allowed only one dropdown to be open at a time (FIG. 6B, C), while weather. com supported multiple (FIG. 6B, D).

### 3.3 Existing Customizability Features

In addition to the previously mentioned dimensions, existing customizability features for overview-detail interfaces were separately collected and coded. It was found that 8.33% ( 13/156) of websites provided customizations for overview-detail interfaces, with 2.56% ( 4/156) providing content customization, 0% ( 0/156) providing composition customization, and 7.69% ( 12/156) providing layout customization. All of the instances collected were limited in customization, with the most providing eight layout variations.

Craigslist was found as offering the most variations for customizing the overview-detail interface, with five options for customizing the overview layout and three for the overview-detail layout. The choice of layout also indirectly influenced which attributes were displayed. For example, the grid view included an image thumbnail, while the list view did not, likely to maintain a more compact presentation. In the content dimension, four websites that allowed users to customize which content attributes they wanted to view were observed. Among these, eBay offered the most customization options, though it only allowed users to toggle six attributes.

### 4 Example Interaction Techniques for Malleable Overview-Detail UIs

This section describes interaction techniques to customize overview-detail interfaces along the three dimensions identified from the content analysis.

### 4.1 Content

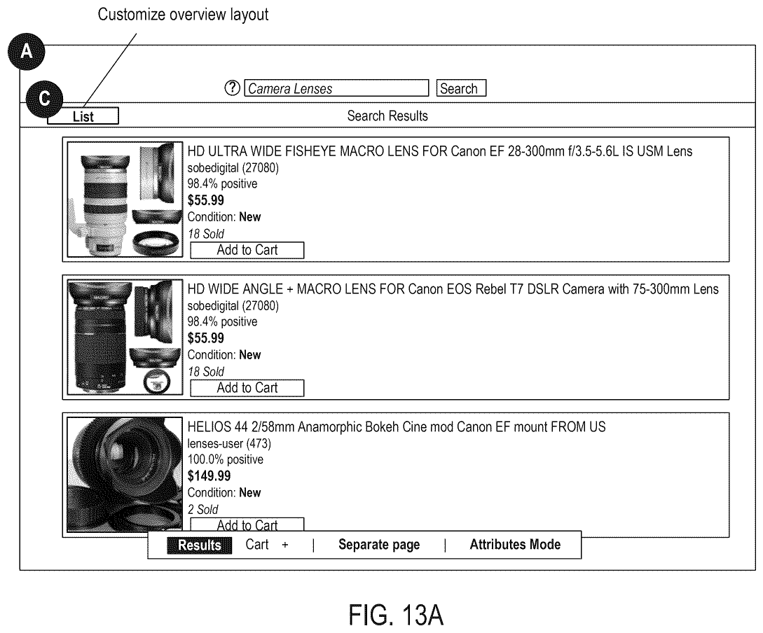

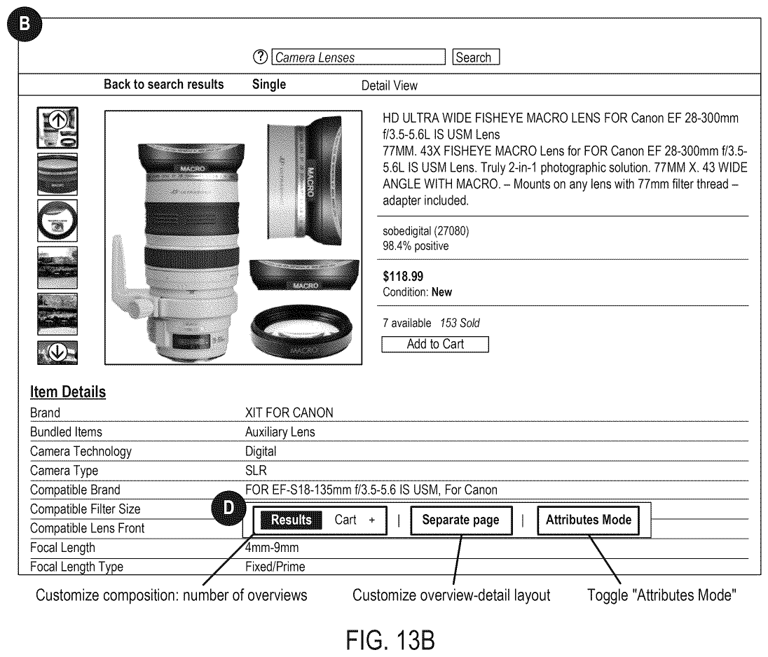

In some embodiments, customization of overview-detail interfaces along the content dimension is enabled using Fluid Attributes, a set of interaction techniques that allows end-users to directly interact with detail attributes in the overview-detail interface. This enables users to control what, where, and how detail attributes are shown, as well as directly sort and filter by attributes. Fluid Attributes also unlocks further customizations in overview-detail interfaces when paired with generative AI tools by allowing users to query, generate, and reformat attributes. To support such interactions, overview-detail interfaces can provide a dedicated “Attributes Mode”, available to toggle on and off in a global toolbar on the website (FIG. 13B, D). Upon receiving a user input indicative of toggling on, the website highlights all attributes in the overview-detail interface, presenting users with affordances to manipulate and operate on the attributes.

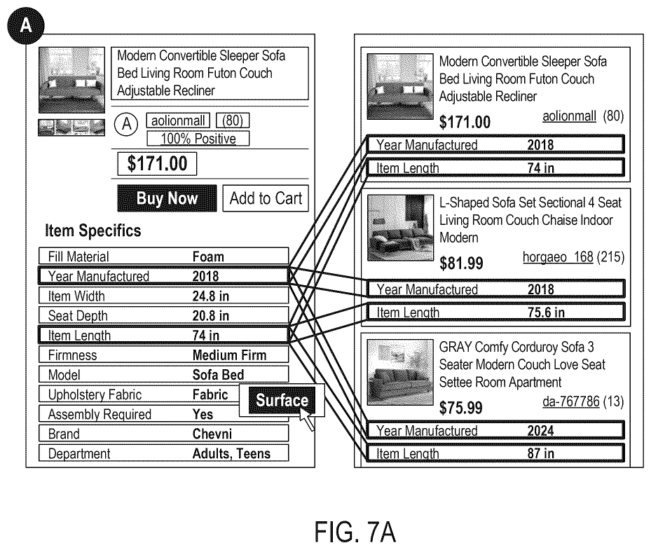

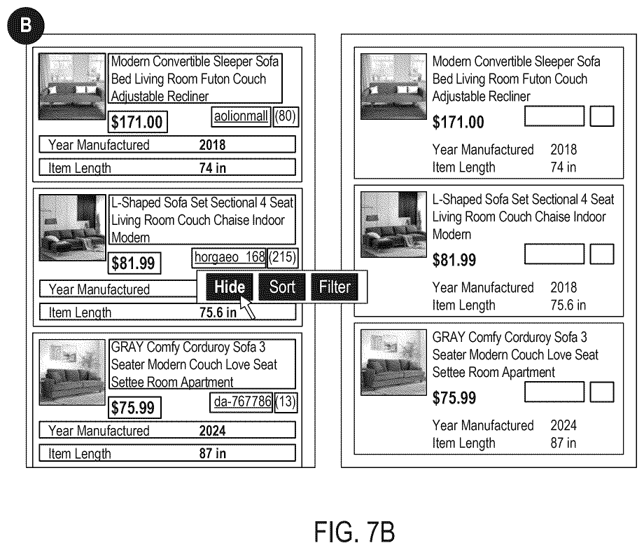

FIG. 7A and &7B illustrate examples of surfacing and hiding attributes based on user input. In order to find details of items not shown in the overview, users must open the detail view of each individual item and locate the attribute in the interface. Fluid Attributes lets users select attributes from the detail view and directly surface them by clicking “Surface” (FIG. 7A). The selected attributes then populate in every item of the overview. On the other hand, if users want to hide attributes they are not interested in seeing in the overview, they can instead “Hide” those attributes (FIG. 7B). In essence, this interaction gives users the control to get an overview of only the things they want by manipulating attributes on their own, without the help from the developers.

In some embodiments, Fluid Attributes is not limited to static attributes; it also includes dynamic and interactive elements such as widgets, buttons, and components. For instance, users can surface an image gallery component into the overview to view more images and even the Add to Wishlist button for each item on a shopping interface.

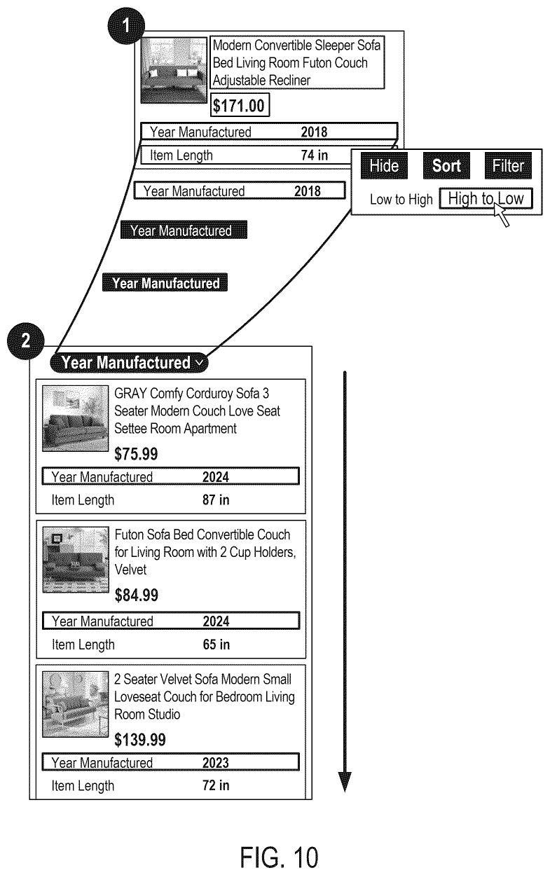

FIG. 10 illustrates an example of sorting and filtering with attributes. Rather than relying on a predetermined set of sort and filter functionalities given by the interface, Fluid Attributes provides the opportunity to make any attribute sortable and filterable. For example, users can surface the Year Manufactured attribute of a couch (FIGS. 10, 1), then directly sort them by the latest manufactured year (FIGS. 10, 2). Since Fluid Attributes also includes dynamic attributes, users can, for instance, sort by the boolean value associated with the Add to Wishlist button to “pin” items to the top of the search results.

In some embodiments, Fluid Attributes, when assisted by AI's ability to process natural language queries to functionalities, demonstrates further interaction possibilities to customize the content in the overview-detail interface. Users can leverage AI through a prompt box provided by the interface.

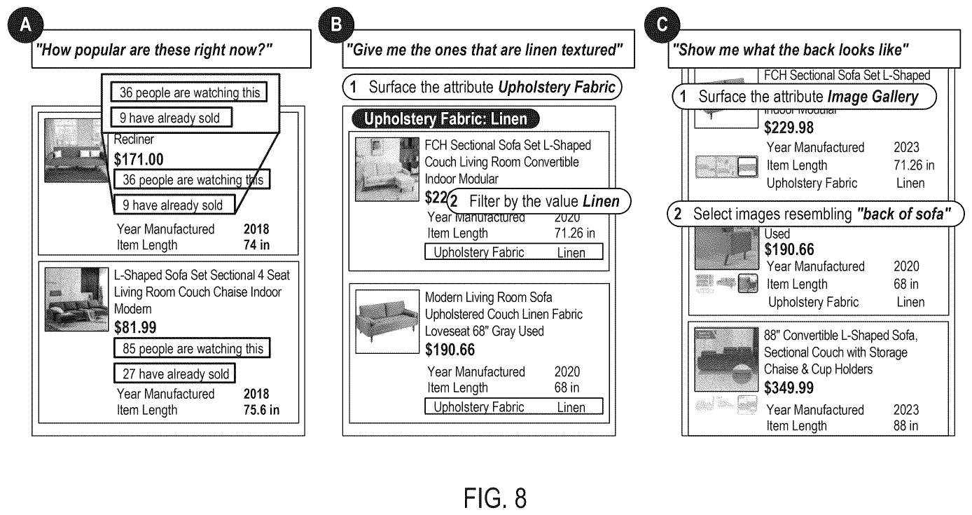

FIG. 8 illustrates an example of Fluid Attributes via natural language queries. To customize attributes with natural language queries, users can for instance ask AI in a prompt box “How popular are these items?”, to which AI will identify relevant attributes (i.e., Number of Watchers, Items Sold) and surface them to the overview (FIG. 8, A). This extends to the other operations in Fluid Attributes, such as adding a filter upon asking for “only couches with a linen texture” (FIG. 8,B). Users can also ask to see “the back of the couches”, triggering AI to surface the Image Gallery attribute and select images that contain a back view of the couch (FIG. 8, C). If AI fails to show this image, the user can always manually look through the images with the surfaced Image Gallery component.

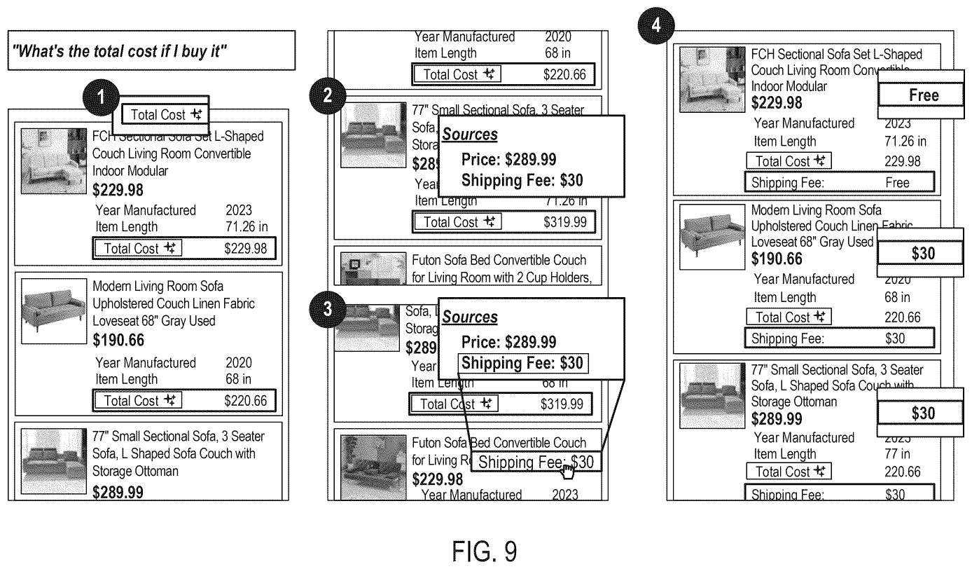

FIG. 9 illustrates an example of generating new attributes. AI is also suited to generate new attributes from user queries. Users can ask for an attribute that may require computing values for each item in the overview. For instance, if a user asks for the “total cost” of an item, AI can sum values of attributes such as Price and Shipping Fee to create a new Total Cost attribute (FIGS. 9, 1). Users can hover over the newly generated attribute to reveal the source attributes the AI referenced (FIGS. 9, 2), and then surface these sources as well (FIGS. 9, 3 and 4). If AI cannot provide the value for an item, it responds “Not Specified”.

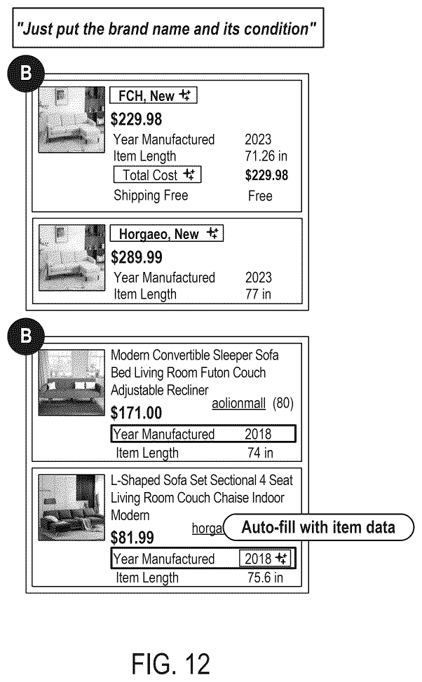

FIG. 12 illustrates an example of establishing consistent attribute values. Many attributes of items in online marketplaces are set not only by developers, but also by vendors. This results in many inconsistent attributes and values, such as different labels, currencies, units, and title formats. If users surface an attribute that is not found in other items, AI can scan through the item's data to identify the attribute from other sources and fill them automatically (FIG. 12, B). Users can also reformat attributes to make them inconsistent across all items. For instance, users can select the title attribute and either ask to “make them consistent” or make precise changes and ask to “show only the brand and the couch's condition” (FIG. 12, A).

### 4.2 Composition and Layout

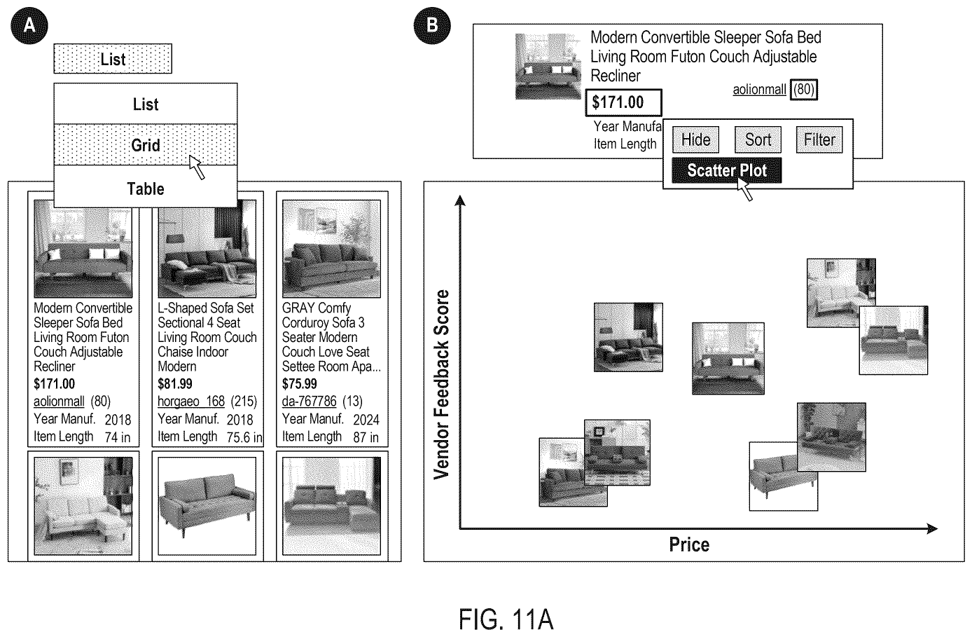

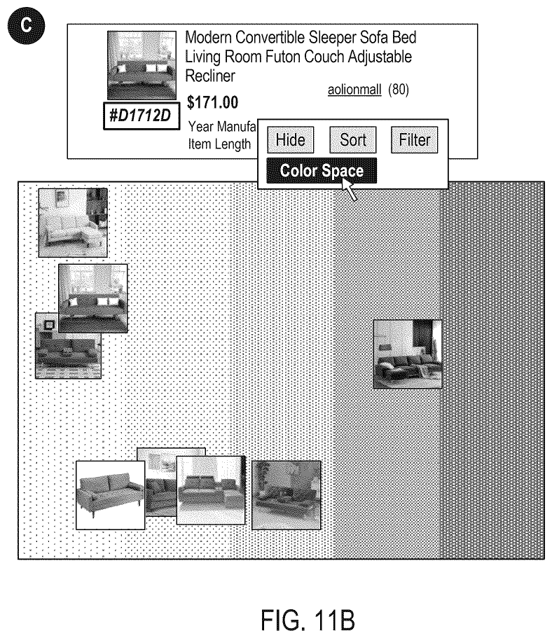

To customize composition and layout, malleable overview-detail interfaces can provide variations identified by the design space from Section 3. To make transforming between such variations most familiar to end-users, dropdown menus are provided for overview and overview-detail layouts and tabbed views are provided to present and help manage multiple overviews (FIG. 11A, A; FIGS. 13A and 13B). By implementing these familiar interaction techniques, we aim to keep the interface customizations user-friendly.

However, other overview-detail systems may support a greater variety of overview representations to meet diverse needs, which, when listed in a dropdown menu, can become large and overwhelming for the user. We recognize that attributes are closely associated with their overview representations, as they are mapped to specific visual elements or data points within the overview. Fluid Attributes leverages this property by enabling users to select desired properties and reveal relevant overviews in various representations. For instance, users can select the Price and Vendor Feedback Score attributes to view items in a scatter plot to consider the reliability of the vendors while comparing prices (FIG. 11A, B). Users can also generate a color attribute from the item image to map items onto spatial overviews such as a color space, allowing users to cluster and explore items by color, similar to Histomages (FIG. 11B, C). A scatter plot and color space are just two examples of overviews; other malleable overview-detail interfaces can offer additional representations and more nuanced variations of scatter plots and color spaces. Instead of aiming to provide all possible overview representations, our goal is to offer a solution that allows users to intuitively and flexibly modify how their overview is represented.

### 5 Example Applications of Malleable Overview-Detail Interfaces

To demonstrate the generalizability of our presented customization techniques, five overview-detail interfaces for various contexts and platforms were developed: online shopping, hotel booking, managing emails, reading live articles, and ordering food on a mobile app. The shopping and booking websites were developed with higher fidelity than the others to use them as design probes for the user study. These two probes are described in more detail in Section 6.1.

### 5.1 Scenarios

FIGS. 13A and 13B illustrate an example of online shopping. Online shopping websites commonly present a search result of items as a list overview with predefined attributes (e.g., item thumbnail, “Add to Cart” button) (FIG. 13A, A) and a detail view in a new page (FIG. 13B, B). However, this default requires users to repeatedly switch between both views to either view specific details or fully browse through individual items. A malleable overview-detail interface can instead provide a toolbar UI that presents options for the user to open detail views side-by-side or in-place with a dropdown (FIG. 13A, C). Additionally, users can add more overviews to save items in different collections (FIG. 13B, D). This can be used to compare sets of choices such as combinations of camera bodies and camera lenses to purchase. Furthermore, users can surface attributes in the overview by toggling on “Attributes Mode” to directly manipulate attributes and form custom abstractions of the interface (FIG. 13B, D).

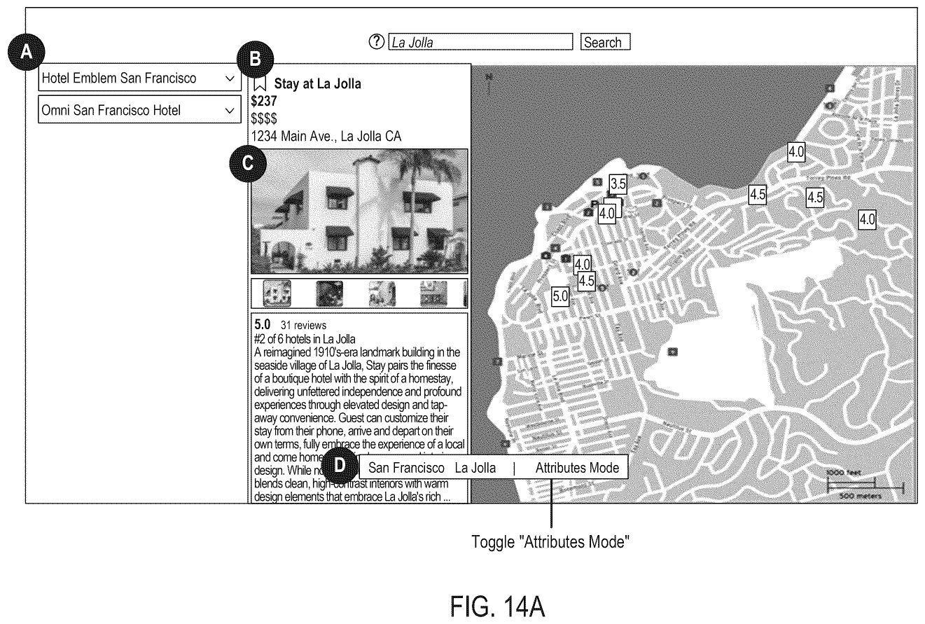

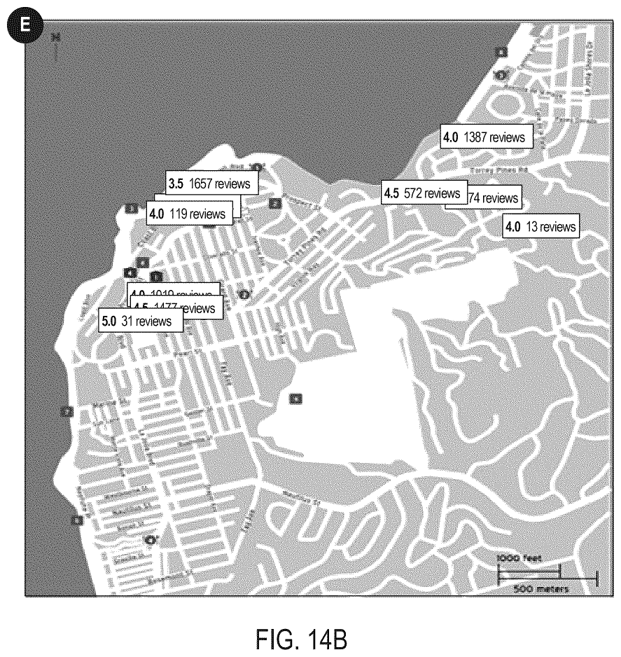

FIGS. 14A and 14B illustrate an example of booking hotels. Hotel booking, home rental, and apartment search websites often provide a list view alongside a map view (FIG. 14A, A and B) to provide rich spatial information. However, these maps often present zero or one attribute for each location, with the only way to view these details being to click on the pin one at a time (FIG. 14A, C). Instead, a malleable overview-detail interface can enable the user to surface more details into the map, such as Rating, Ranking, and Amenities (FIG. 14A, D). Additionally, the user may customize different attributes for different overviews to leverage the benefits and affordances each overview representation provides. For instance, users can surface details about the number of reviewers in the map view to gauge which areas might be more popular (FIG. 14B, E), while they can surface details about amenities in the list view to easily sift through preferences by scrolling.

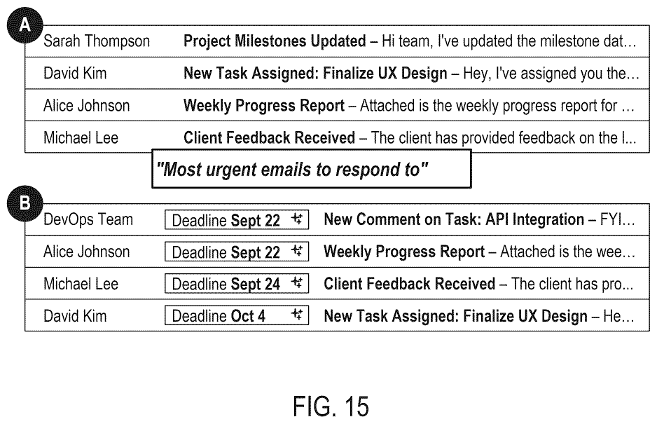

FIG. 15 illustrates an example of reading and managing emails. Oftentimes, emails contain important details in the text of their messages such as a response deadline. However, foraging through a large inbox for these details can grow extremely tedious. Using AI-assisted Fluid Attributes, users can prompt the interface to generate an attribute Response Deadline (FIG. 15A), surface it in the overview, and sort the emails by upcoming deadlines (FIG. 15B). Users can also choose to open emails in-place rather than side-by-side or on a new page, allowing them to fully read through important ones and quickly glance at less important ones.

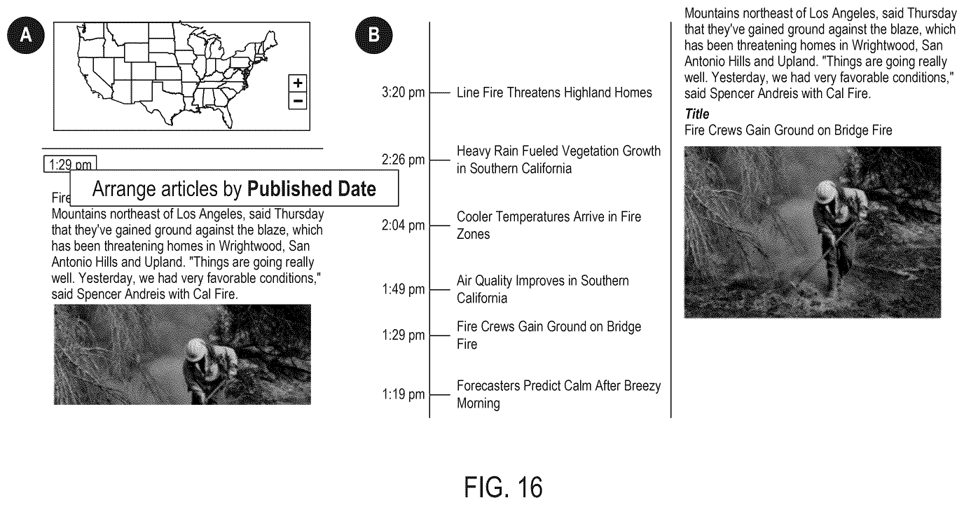

FIG. 16 illustrates an example of reading live articles. Live news articles report on long-standing events such as presidential elections and sports games. These interfaces appear to aggregate shorter articles in a scrollable stack (FIG. 16, A). However, it can be challenging for users joining in the middle of the event to quickly catch up on the timeline with a long document. To address this, users can select the Published Date attribute and bind it to a timeline overview, organizing all articles into a timeline. Users can also select which details to show in the timeline before diving into individual articles (FIG. 16, B).

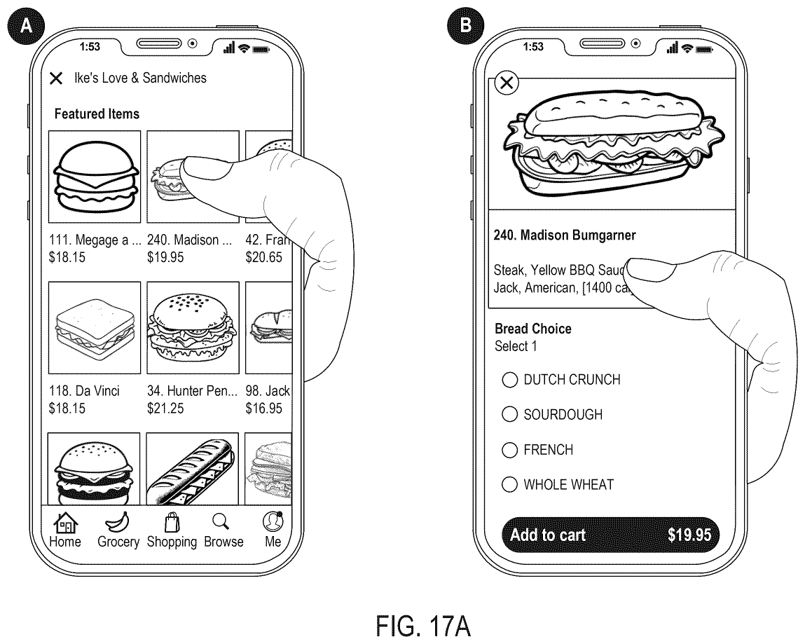

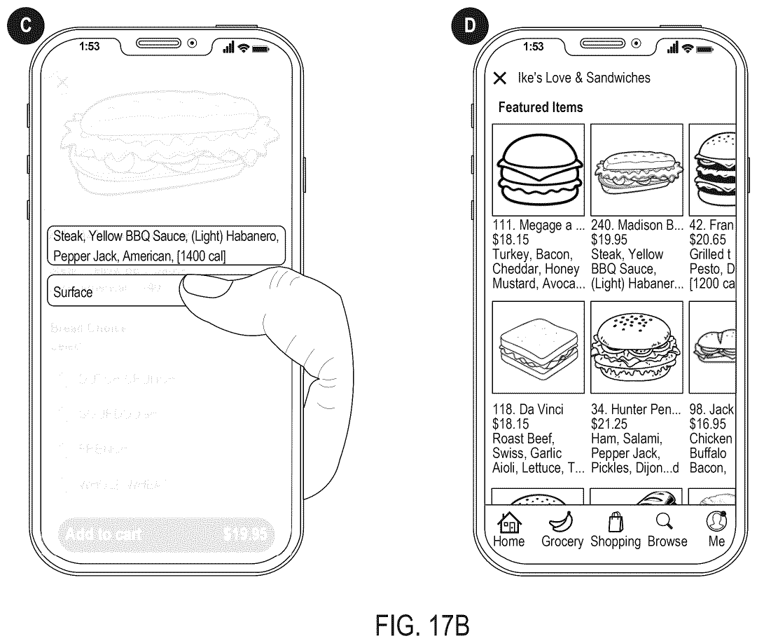

FIGS. 17A and 17B illustrates an example of mobile applications for food delivery. The overview-detail design pattern is also present across diverse platforms such as mobile devices. We recognize that our presented customization techniques can translate to these platforms as well. When ordering food on a mobile delivery app, some attributes are not shown in the overview. For instance, Doordash shows prices and thumbnails of menu items to show what is popular (FIG. 17A, A), but do not show descriptions—which includes the calories. An implementation of Fluid Attributes in this app could allow calorie-conscious individuals to check which items best suit their needs by surfacing the calorie count into the overview. Users can easily invoke Fluid Attributes on mobile devices by long-pressing an attribute (FIG. 17A, B), which opens a context menu with available customizations, such as the “Surface” option (FIG. 17B, C). Tapping this option instantly reveals the calories for all items, eliminating the need to further switch between views (FIG. 17B, D).

### 5.2 Implementation Details

In some embodiments, the desktop web applications are implemented in Next.js, a React web framework, whereas the mobile applications are implemented in SwiftUI. eBay's API was used to provide results in the shopping website and Tripadvisor's API was used to provide results in the hotel booking website. The high-fidelity probes stored all customization settings to log them for the user study. Other applications stored customizations locally on the application's client.

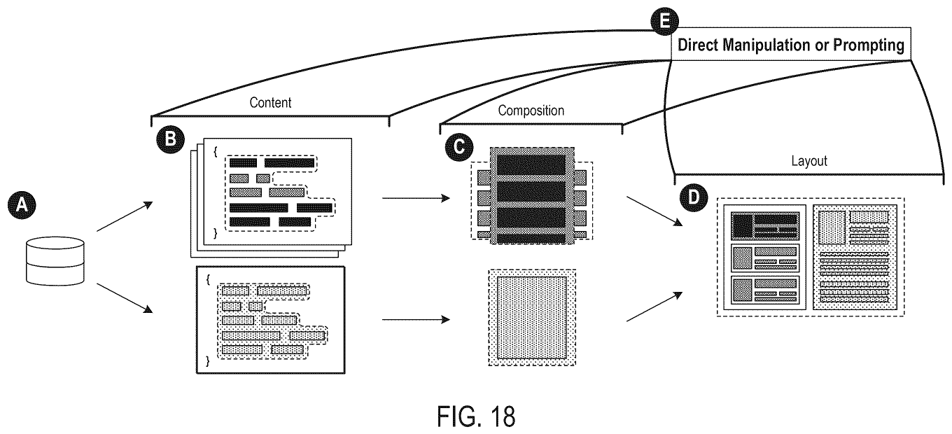

FIG. 18 illustrates and details the pipeline of the system diagram of the malleable overview-detail implementations. As shown therein, the end-user can make customizations across the three dimensions, corresponding to the system's three components. In our applications, content customization is implemented such that all data is fetched to the front-end, and the management of visible attributes is entirely client-side. However, other implementations can opt to fetch data attributes dynamically to minimize unnecessary database calls. Both composition and layout customizations are also managed on the client side.

In some embodiments, AI is implemented to customize the content dimension only. In other embodiments, AI can also manipulate the other two dimensions. Since all customization actions are performed through individual settings within the system, these settings can be made accessible for AI to modify based on their relevance to the user's prompt. This enables AI to sequence multiple customization operations together across different dimensions.

### 6 Example User Study

Two high-fidelity applications (shopping and hotel booking) were used to understand how effectively users might customize malleable overview-detail interfaces and to observe emergent usage patterns as they utilize overview-detail interface customizations to best fit their needs and preferences. In particular, the following aspects were considered:
(1) How effectively can users perform customizations on malleable overview-detail interfaces?
(2) What kinds of customization workflows and usage patterns emerge when interacting with malleable overview-detail interfaces?
(3) What additional customizations did users seek that were not supported by our design probes?

### 6.1 Examples of Design Probes

Shopping and hotel booking websites were selected in order to approximate a common yet complex, real-world scenario of using malleable overview-detail interfaces. To focus the study on observing the use of the key customization features, a subset of features that are demonstrated in Section 4 were selected.

In the shopping website's content dimension, the design probe included surfacing, hiding, sorting, and filtering by attributes, prompting AI to surface and generate new attributes, and auto-fill attribute values. Users can also sort and filter by attributes of each item. For composition, users were enabled to add, remove, and rename multiple overviews. For overview layouts, list, grid, and table views were provided, and for overview-detail layouts, new page, side-by-side, dropdown, and pop-up layouts were provided. For the booking website, only the content dimension was supported to further investigate how users surface and hide attributes and to observe potential workflow differences compared to the shopping website. Upon surfacing attributes on the booking website, users were given the option to surface them to a map, the bookmarks list, or both.

### 6.2 Default Configurations

The overview-detail interface probes were configured with default settings to be intuitive for participants to quickly get accustomed to. The shopping site displayed the search results as a list overview of items. The overview-detail layout was by default a new page, and the detail view displayed one item at a time. A second list overview named “Cart”, which displayed a grid layout of the items that were added to it, was additionally provided. Each item in the overview displayed the following attributes: Title, Thumbnail Image, Vendor Username, Vendor Feedback Score, Vendor Feedback Percentage, Product Price, Product Condition, Number of Products Sold, and an Add to Cart button. The booking site utilized two different overviews: a map overview and an overview list of bookmarks. Upon entering the interface, the map view displayed the Rating attribute of each hotel, and upon adding items the bookmark list, the Hotel Name attribute was displayed by default.

### 6.3 Procedure

A 90-minute study, which began with a brief introduction of overview-detail interfaces to familiarize participants with the concepts and terminology used throughout the study (<1 min), was conducted. Then, two 35-minute sessions, first on the booking task and second on the shopping task were run. The study began with the booking task because it contained a smaller feature set which could more easily acclimate users to both websites. During each session, users were given a tutorial of our system, which included explanations of each feature, as well as mini-tasks to acclimate participants to the probes and discover preferred customizations (˜10 min). The study then proceeded onto the main task, in which participants were given a task prompt and asked to think out loud (˜20 min). After each task, participants completed a questionnaire (7-point Likert scale) to share their experience with the probe (˜5 min).

The hotel booking task description and criteria was as follows:
You are traveling to the Bay Area for meetings. You will stay in two different locations, one night per stay and will need to find a hotel for each: San Francisco and San Jose.
Your total budget is 350 USD.
You want to eat at the hotel (or hotel room) as much as possible (strong preference for hotels with included breakfast or room service).
You prefer modern and new hotels over traditional or old ones.
You would like to stay one night at a premium or luxurious hotel.

Our shopping task description and criteria was as follows:
You are choosing two monitors: one for your home and one for your workplace.
Your total budget for two monitors is 250 USD.

Criteria for monitor at home:
You want a decent deal.
You want the highest resolution possible, 4k or maybe better.
The monitor should take up minimum space on your desk.

Criteria for monitor at work:
The condition of the monitor is most important.
You want a display that's decently sized, but also with high pixel density (resolution/display size).
You don't need a monitor stand—assume the office already provides one.

At the end of the session, participants were interviewed to reflect and share their overall experience (˜20 min).

### 6.4 Measurements

To observe patterns in the tasks, the types of customizations users made, the frequency with which they made specific customizations, and the attributes they surfaced or hid from the overviews were loggde. To capture context and insights into participants'behaviors, both screen activity and audio were recorded.

### 7 Example User Study Results

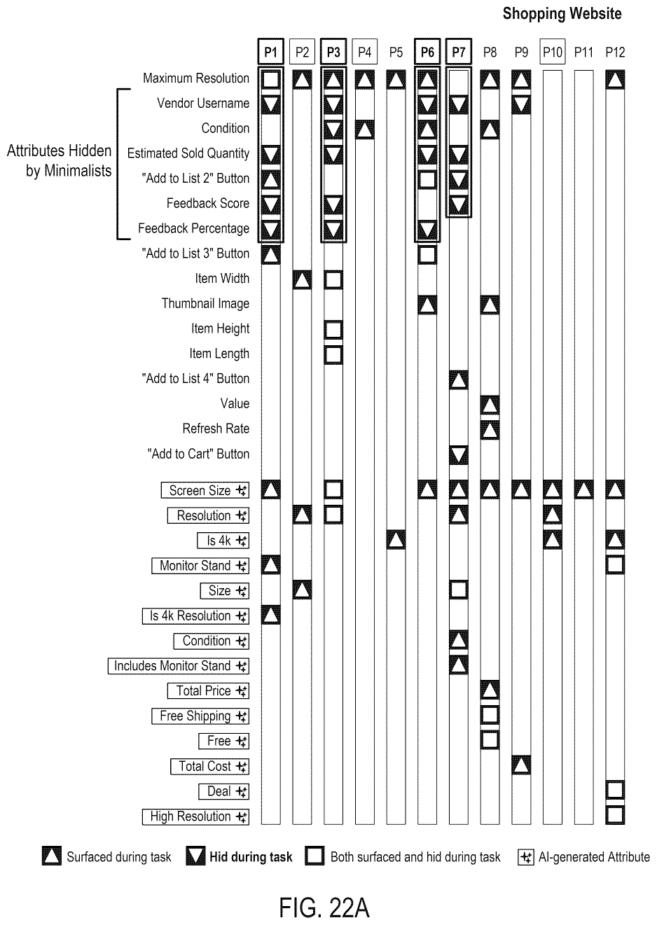

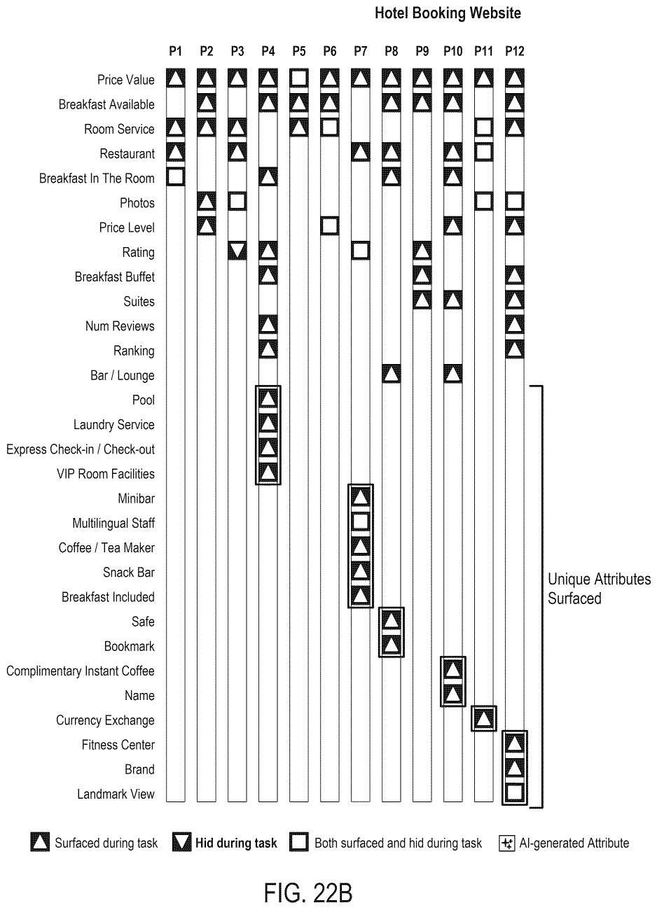

First, it was observed that the participants made diverse customizations even when given the same shopping and booking tasks and the same starting interface configurations, suggesting that the customizations provided by malleable overview-detail interfaces are beneficial and desired. Many participants surfaced attributes that others had not, as illustrated in FIG. 22B. Some participants used multiple overviews for saving monitors into work and home lists (P1, P2, P6, P7, P12), while others created one intermediate space for candidate items (P3, P4, P8, P9, P10). While a majority of participants used the side-by-side overview-detail layout (P1, P2, P4˜P12), P3 preferred to use the pop-up view, while P12 preferred both the dropdown and side-by-side views. Additionally, participants relied on a broad variety and combination of overview layouts between the list (P1˜4, P7, P9, P10), grid (P2˜5, P8, P10, P11), and table (P6, P11, P12). For instance, P4 used both grid and list views, while P6 used both table and list views together.

Findings for each of the aspects discussed above are now discussed.
(1) How effectively can users perform customizations on malleable overview-detail interfaces?

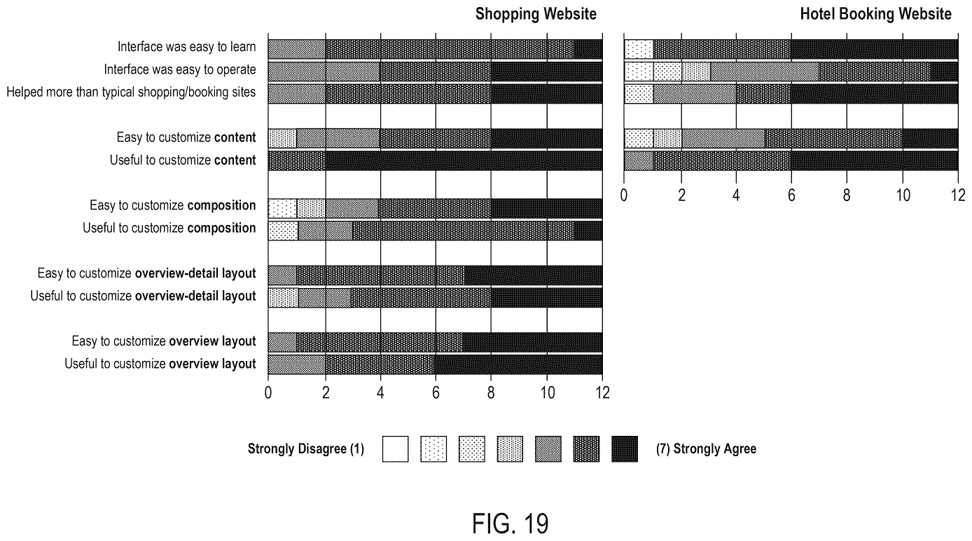

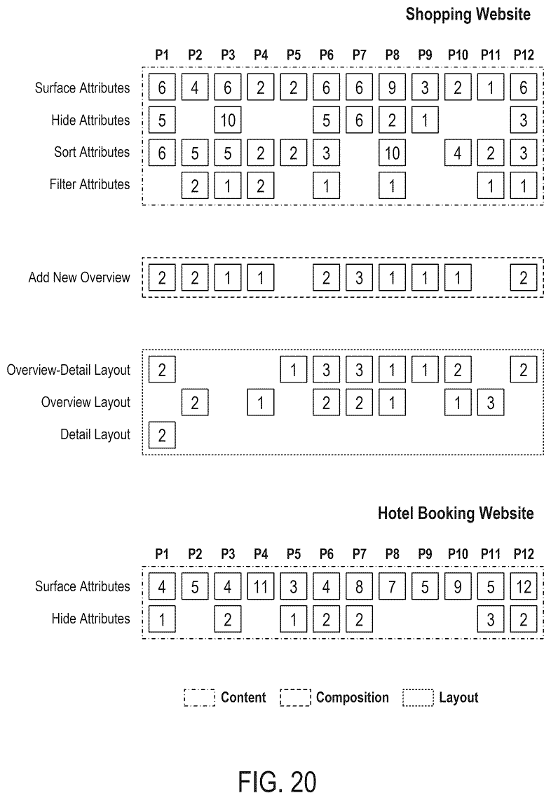

All participants completed both tasks within the provided time. They reported that the interfaces of both probes were easy to learn (booking: 11/12; shopping: 12/12) and operate (booking: 9/12; shopping 12/12), and most agreed it was useful to customize content (booking: 6/12 strongly agree; shopping: 10/12 strongly agree), composition (11/12), and layout (overview-detail: 11/12; overview: 12/12) (FIG. 19). All participants surfaced attributes on both websites, while 9/12 participants hid attributes on at least one of them, and 10/12 participants sorted or filtered by attributes on the shopping website. Most participants also customized the composition (10/12) and layout (11/12) of the shopping website (FIG. 20).

The study also measured how often participants made customization operations. On average, participants made 1.80 customizations per minute during the booking task (SD=0.74) and 0.86 customizations per minute during the shopping task (SD=0.48). During their task, participants made an average of 22.08 content customizations (SD=12.29), 1.33 composition customizations (SD=0.84), and 2.17 layout customizations (SD=1.52). These results suggest that our participants were able to effectively utilize the customizations provided to them and understood the value of malleable overview-detail interfaces. P1 described how the customizability features allowed them to feel more in control over the interface, saying: “The ability to choose exactly what I wanted on my screen and close everything else was super nice. You can't really do [that] with a lot of sites. Like, it is what it is.”

Fluid Attributes reduces excessive context-switching. Participants explained that the utility of customizations came from its ability to avoid unnecessary navigation by bringing all details of interest into a single space. P3 stated, “with a lot of websites that you can't really customize, you end up having to open the products one by one to look at all the specifications, which takes longer. I think it's nice to be able to just see it all as you're scrolling through.” P4 similarly described their experience with the booking website compared to other commercial websites, saying, “Websites like Booking.com, Expedia, and Airbnb don't have these options. You have to literally look for each and everything. On the booking website, where only the options you want are displayed, it's very easy.”

Fluid Attributes helps users align the interface with their decision criteria. Additionally, some participants shared that customizing content helped align the information they wanted to see on the website with their decision-making criteria. P12 said: “After reading the information, I kind of have some criteria in my mind of which features I probably want, so I will only concentrate on these features. [With the hotel booking website], I can just customize what information I really want to focus on. For example, I personally really prefer the ratings.”

AI-assisted Fluid Attributes reduces the need to sift through detail. The study also observed almost all participants surfaced or generated attributes with AI (11/12). P12, who surfaced 5/6 attributes by prompting AI, found prompting the interface the most convenient as it gave them direct answers, stating: “I'm a very lazy person, so I'll rely on this feature because I don't want to click on each [item] and check whether they are 4k monitors.” P10 also appreciated the help from AI because they no longer felt “confined to certain characteristics” provided by each item. They further described how they found one shopping item that contained the Material attribute, but noticed it did not exist for all items. Instead of manually verifying whether items are missing the attribute or have it inconsistently named, they could use AI to verify it in a single action.
(2) What are the different workflows and usage patterns of malleable overview-detail interfaces?

Findings from (1) demonstrate that malleable overview-detail interfaces are both effective and preferred by our participants, as the supported customizations allowed them to achieve their desired configurations. In addition to enabling these configurations, the study was also concerned with how to enable users to reach these configurations more quickly. Therefore, it aimed to identify the types of overview-detail configurations users prefer, which could be provided as defaults to different user groups in future interfaces to reduce the number of customization they need to perform.

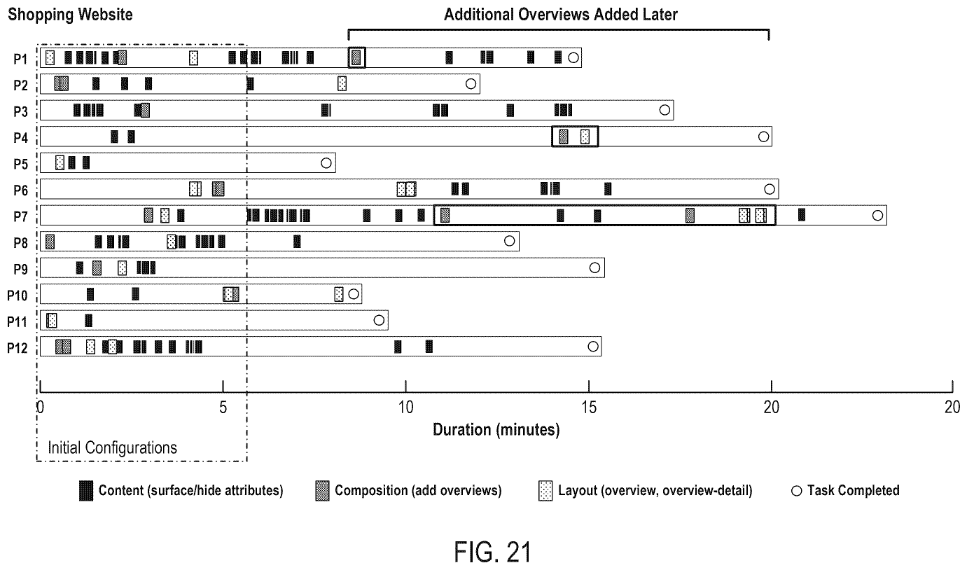

Customizing at the start and throughout. Logs of participants' customizations made throughout their shopping task are illustrated in FIG. 21. While many participants began their task by making initial configurations of their overview-detail interface (P1˜P5, P8˜P12), many also continued to make customizations throughout (P1˜P4, P6˜P8, P10, P12). For instance, P3 initially surfaced attributes that best aligned with their criteria, but changed their set of surfaced attributes as they compared between more choices. Additionally, some participants added multiple overviews from the start (P1˜P3, P6˜P9, P12), while some added them ad hoc when they needed to save and directly compare between choices (P1, P4, P7, P10). P1, who continuously transformed their interface throughout their task, expressed the desire to stay in Attributes Mode, while P11, who preferred to “customize once and be done”, suggested a dedicated customizations page to make their configurations in one place. Furthermore, P6 even expressed a desire to use their table and list configuration from the shopping website for the booking website as well. They noted that, for tasks like these, they almost always default to using a spreadsheet application as their go-to tool for managing and organizing information. To support users who continuously make customizations throughout their task, interfaces could reduce the friction of making these customization options with more direct manipulation interactions, keyboard shortcuts, or in-situ settings on the interface. On the other hand, those who make initial configurations could benefit from a central settings page with available customization options, popular default configurations that users can access at any point, and if possible, saved customizations across different tasks and websites.

Common sequences of customizations. Most common sequences that we observed involved semantically related customizations, such as surfacing multiple attributes all relating to hotel food services or creating a new overview and immediately changing its layout. We also observed cases when participants sorted or filtered by values of attributes they had immediately surfaced (P2˜4, P6, P8, P10, P11), suggesting a common surface-then-sort and surface-then-filter workflow. Interfaces can reduce the number of clicks by enabling interactions for creating and using composable operations, where developers can set defaults, end-users can construct their own, and AI can generate them as well.

Hoarders and Minimalists. Prior research has identified tendencies when managing digital information along the spectrum of two extremes: hoarding and minimalism. The study found that this behavior also emerged when users were given the ability to surface or hide attributes in our probes (FIGS. 22A and 22B):
1. Hoarders (P2, P4, P10): Participants who did not hide any attributes from the overview.
2. Minimalists (P1, P3, P6, P7): Participants who deliberately hid attributes from the overview.

P2 (Hoarder) did not hide any attributes in the overview, including ones they surfaced manually from the detail view or by using AI. They reasoned, “hiding it has a bigger inertia for me to overcome because if I want it back, I would feel like I wasted more effort to remove it and bring it back again.” They further explained that this is their natural tendency, as they also clutter their screen with many tabs. On the contrary, P3 (Minimalist), who hid five default attributes from the shopping website and one default attribute on the hotel booking website, admitted to the higher effort, but also advocated for the reward, stating, “it probably takes longer to set it up the way I want it, but also then it's easier to look through because I'm not getting irrelevant stuff.”

Hoarders may be more resilient to clutter in the overview but less resilient to repeatedly surfacing information from the detail view. For them, an interface that packs most information in the overview, allowing them to sift through it themselves, would be preferable. In contrast, Minimalists value the limited space in the overview and prefer to “keep the space clean.” For them, a blank slate in the overview, allowing them to choose which attributes to display, would be more preferable. For those who fall between these extremes, a setting to control a maximum number of attributes shown in the overview, automatically hiding less important ones when more are surfaced, may also be preferable.

Utilizing the overview composition and layout to structure tasks. Among the 10/12 participants that used multiple overviews in shopping probe, five of them (P1, P2, P6, P7, P12) utilized two overviews: one for each monitor type (work and home). For instance, P12 opened only one overview at a time when finding monitors of each type to offload important information for later, saying, “It gives me some mental space where I can preserve it.” They also appreciated how they could open both spaces at once when they needed to compare between the two overviews. P6 did the same, but additionally split their budget into each overview, allocating $150 for the work monitor and $100 for the home monitor.

The behaviors of these participants hint at a pattern of utilizing the overview composition and layout to manage sub-tasks. To support this usage pattern, future implementations of malleable overview-detail interfaces can provide support for nested or linked overviews, created either manually or with AI. This can allow users to break complex tasks into more manageable, hierarchical subtasks or linearly order overviews to queue sequentially dependent tasks. This aligns with literature that take the task-centric approach to provide hierarchically organized browser tabs, dedicated desktop spaces, and dynamically linked email threads.
(3) What additional customizations did users seek that were not supported by our design probes?

Choose how detail views are invoked (P6). Although the study implemented the probes to open detail views by clicking, P6 suggested the probes to allow users to also open details by hovering. They further described how they would also want a “less maximized” view of the details, suggesting the desire to invoke multiple detail views with different sets of attributes in different ways.

Attributes about all items in the overview (P6, P10, P12). Participants wanted details across all items in the overview in addition to ones provided for each item. For instance, P6 wanted to calculate the total price of all their bookmarked hotels, while P10 wanted the “best price” based on multiple attributes they surfaced. Indeed, if the detail view can have attributes about an item, the overview can have attributes about the entire collection. Future implementations of malleable overview-detail interfaces should explore how this can be supported.

### 8 Example Embodiments of the Disclosed Technology

Embodiments of the disclosed technology provide malleable overview-detail interfaces that end-users can customize to address individual needs. A content analysis of existing overview-detail interfaces in the wild was conducted and a design space with three dimensions of variation: content, composition, and layout, was constructed. Based on these dimensions, interaction techniques to support customization, enabling end-users to customize diverse layouts, compositions of views, manipulable attributes across views, and AI-driven interactions to reformat and generate new attributes, were developed. The user study found that participants produced diverse customizations, surfacing key insights into usage patterns in how they customized overview-detail interfaces.

In some embodiments, additional design probes are implemented in contexts beyond shopping and hotel booking to offer insights into which variations and instances users might prefer under different scenarios and gain stronger evidence of various usage patterns.

In some embodiments, the described pipeline can be configured as a developer toolkit, such as a web framework, that provides many variations and customizations out of the box. This framework can package together an architecture involving GraphQL to dynamically fetch attributes from the back-end and a custom UI component library that provides sets of layouts and compositions to use as defaults and for end-users to customize. While a developer toolkit may be less viable for existing websites, this approach significantly reduces the cost for developers building new ones.

Diverse forms of abstractions are implemented in various information systems and digital artifacts to assist users in understanding, operating with, and communicating with complex knowledge. For instance, scientific data, mechanical systems, and code are often abstracted into various visualizations and diagrams, which involve the use of ellipses, blocks and arrows, and graphs. Recent advancements in AI have also enabled the development of generating different levels of abstractions of text and different summarizations of academic papers. In some embodiments, dynamic abstractions in the context of overview-detail interfaces are configured, enabling end-users to modify a custom set of attributes. In other embodiments, users can go beyond modifying data attributes to convivially creating and tailoring their own abstractions involving semantics of text and data through AI and visual encodings with UI style.

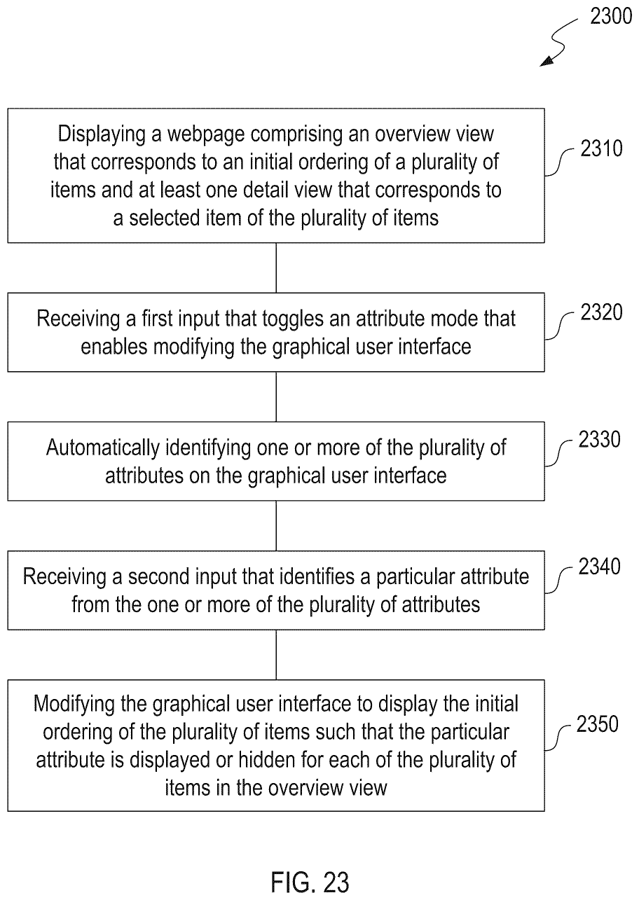

The various above-described aspects of malleable overview-detail UIs are highlighted in the following technical solutions:
S1. A method (e.g., method 2300 in FIG. 23) of interacting with a graphical user interface, comprising: displaying (2310), on the graphical user interface, a webpage comprising an overview view that corresponds to an initial ordering of a plurality of items and at least one detail view that corresponds to a selected item of the plurality of items, wherein each item comprises a plurality of attributes; receiving (2320), via the graphical user interface, a first input that toggles an attributes mode that enables modifying the graphical user interface; automatically identifying (2330), subsequent to receiving the first input, one or more of the plurality of attributes on the graphical user interface; receiving (2340), via the graphical user interface, a second input that identifies a particular attribute from the one or more of the plurality of attributes; and modifying (2350), based on the second input, the graphical user interface to display the initial ordering of the plurality of items such that the particular attribute is displayed or hidden for each item in the overview view. As discussed in this patent document, surfacing the particular attribute comprises identifying an attribute in the at least one detail view and then modifying (or reformatting) the overview view to ensure that the particular attribute is consistently added to (or deleted from) each of the plurality of items (in the original, or initial, ordering) in the overview view. As described, surfacing an attribute in the described malleable overview-detail interfaces can be performed in addition to sorting and filtering. That is, the malleable overview-detail interfaces enable the user's specific preference when looking at a detail view to be propagated to all the other items in the overview view. Subsequent to the surfacing, the plurality of items in the overview view may be sorted (e.g., solutions S6 and S7) and/or filtered (e.g., solution S8) based on the particular attribute.
S2. The method of solution S1, wherein automatically identifying the one or more of the plurality of attributes is based on analyzing the webpage with respect to a content dimension, a composition dimension, and a layout dimension, and wherein the content dimension describes whether information is present in the overview view, the at least one detail view, or both, the composition dimension describes how the overview view and the at least one detail view are connected together, and the layout dimension describes a spatial arrangement of the overview view and the at least one detail view within the graphical user interface.
S3. The method of solution S2, wherein the content dimension comprises at least one of a visual abstraction, a semantic abstraction, or a computational abstraction.
S4. The method of solution S2, wherein the composition dimension comprises at least one of a one-to-one mapping, a many-to-one mapping, or a one-to-many mapping between the overview view and the at least one detail view.
S5. The method of solution S2, wherein the layout dimension comprises at least one of an in-place spatial arrangement, an under-the-overview view spatial arrangement, or an above-the-overview view spatial arrangement, and wherein the overview view comprises a list view, a grid view, a table view, a timeline view, a map view, or a hierarchical structure of views.
S6. The method of solution S1, further comprising: sorting, based on the particular attribute, the plurality of items to generate an updated ordering of the plurality of items that is different from the initial ordering of the plurality of items; and displaying, via the graphical user interface, the updated ordering of the plurality of items in the overview view.
S7. The method of solution S1, further comprising: sorting the plurality of items in an ascending order or a descending order of the particular attribute to generate an updated ordering of the plurality of items; and displaying, within the overview view, the updated ordering of the plurality of items.
S8. The method of solution S1, further comprising: filtering, based on the particular attribute and a threshold value associated with the particular attribute, the plurality of items to generate a filtered plurality of items, wherein each item on the filtered plurality of items is associated with the particular attribute being greater than or less than the threshold value; and displaying, via the graphical user interface, the filtered plurality of items.
S9. The method of solution S1, wherein automatically identifying the one or more of the plurality of attributes comprises: highlighting, within the overview view or the at least one detail view, each of the one or more of the plurality of attributes on the graphical user interface.
S10. The method of solution S1, comprising: receiving, subsequent to modifying the graphical user interface, a natural language prompt related to a characteristic of the plurality of items that is not associated with any of the plurality of attributes; identifying a new attribute that is representative of the characteristic; and updating the overview view to include the new attribute for each of the plurality of items and for the selected item.
S11. The method of solution S1, wherein each of the plurality of attributes comprises a static information element or an interactive element that includes at least one of a button, a text field, a set of radio buttons, a menu, or a multimedia component.

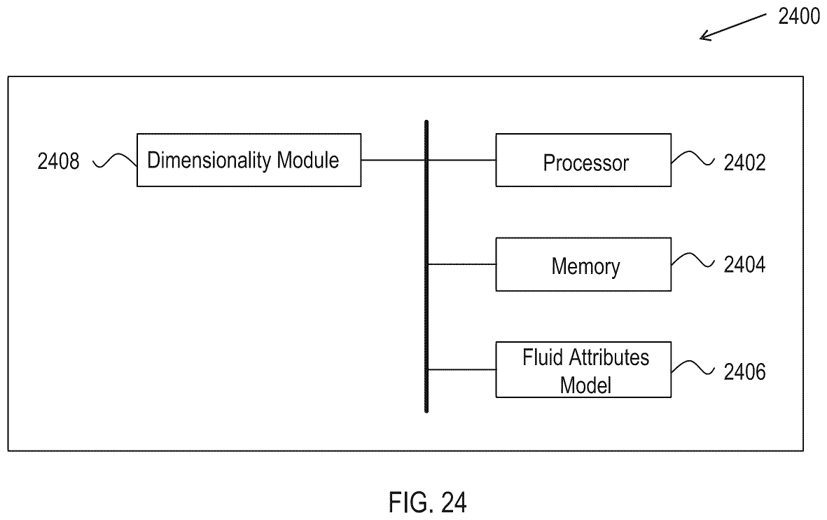

FIG. 24 shows an example of a hardware platform 2400 that can be used to implement some of the techniques described in this patent document. For example, the hardware platform 2400 may implement the various modules and algorithms described herein. The hardware platform 2400 may include a processor 2402 that can execute code to implement a method. The hardware platform 2400 may include a memory 2404 that may be used to store processor-executable code and/or store data. The hardware platform 2400 may further include a fluid attributes module 2406 (e.g., activated upon toggling to Attributes Mode) and a dimensionality module 2408 (e.g., configured to automatically identifying one or more of the plurality of attributes on the graphical user interface), which can communicate with the processor 2402. In some embodiments, the processor 2402 may include one or more processors implementing at least a portion of the fluid attributes module 2406 and the dimensionality module 2408. The processor 2402 may be configured to implement content analysis (e.g., using the dimensionality module 2408) and other UI modification operations (e.g., using the fluid attributes module 2406). In some embodiments, the memory 2404 may include multiple memories, some of which are exclusively used by the processor 2402 when implementing the content analysis and/or UI modification operations.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method of interacting with a graphical user interface, comprising:
displaying, on the graphical user interface, a webpage comprising an overview view that corresponds to an initial ordering of a plurality of items and at least one detail view that corresponds to a selected item of the plurality of items, wherein each item comprises a plurality of attributes;
receiving, via the graphical user interface, a first input that toggles an attributes mode that enables modifying the graphical user interface via the at least one detail view;
automatically identifying, on the at least one detail view, subsequent to receiving the first input, one or more attributes of the plurality of attributes;
receiving, via the graphical user interface, a second input that identifies a particular attribute from the one or more attributes, wherein the particular attribute is not displayed for each of the plurality of items in the overview view; and
modifying, based on the second input, the graphical user interface to display the initial ordering of the plurality of items such that the particular attribute is displayed or hidden for each of the plurality of items in the overview view.

2. The method of claim 1, wherein automatically identifying the one or more attributes is based on analyzing the webpage with respect to a content dimension, a composition dimension, and a layout dimension, and wherein:
the content dimension describes whether information is present in the overview view, the at least one detail view, or both,
the composition dimension describes how the overview view and the at least one detail view are connected together, and
the layout dimension describes a spatial arrangement of the overview view and the at least one detail view within the graphical user interface.

3. The method of claim 2, wherein the content dimension comprises at least one of a visual abstraction, a semantic abstraction, or a computational abstraction.

4. The method of claim 2, wherein the composition dimension comprises at least one of a one-to-one mapping, a many-to-one mapping, or a one-to-many mapping between the overview view and the at least one detail view.

5. The method of claim 2, wherein the layout dimension comprises at least one of an in-place spatial arrangement, an under-the-overview view spatial arrangement, or an above-the-overview view spatial arrangement, and wherein the overview view comprises a list view, a grid view, a table view, a timeline view, a map view, or a hierarchical structure of views.

6. The method of claim 1, further comprising:
sorting, based on the particular attribute, the plurality of items to generate an updated ordering of the plurality of items that is different from the initial ordering of the plurality of items; and
displaying, via the graphical user interface, the updated ordering of the plurality of items in the overview view.

7. The method of claim 1, further comprising:
sorting the plurality of items in an ascending order or a descending order of the particular attribute to generate an updated ordering of the plurality of items; and
displaying, within the overview view, the updated ordering of the plurality of items.

8. The method of claim 1, further comprising:
filtering, based on the particular attribute and a threshold value associated with the particular attribute, the plurality of items to generate a filtered plurality of items, wherein each item on the filtered plurality of items is associated with the particular attribute being greater than or less than the threshold value; and
displaying, via the graphical user interface, the filtered plurality of items.

9. The method of claim 1, wherein automatically identifying the one or more attributes on the at least one detail view comprises:
highlighting, within the overview view or the at least one detail view, each of the one or more attributes on the graphical user interface.

10. The method of claim 1, comprising:
receiving, subsequent to modifying the graphical user interface, a natural language prompt related to a characteristic of the plurality of items that is not associated with any of the plurality of attributes;
identifying a new attribute that is representative of the characteristic; and
updating the overview view to include the new attribute for each of the plurality of items and for the selected item.

11. The method of claim 1, wherein each of the plurality of attributes comprises a static information element or an interactive element that includes at least one of a button, a text field, a set of radio buttons, a menu, or a multimedia component.

12. A system for using overview-detail interfaces, comprising:
a graphical user interface; and
at least one processor configured to:
display, on the graphical user interface, a webpage comprising an overview view that corresponds to an initial ordering of a plurality of items and at least one detail view that corresponds to a selected item of the plurality of items, wherein each item comprises a plurality of attributes;
receive, via the graphical user interface, a first input that toggles an attributes mode that enables modifying the graphical user interface;
automatically identify, subsequent to receiving the first input, one or more attributes of the plurality of attributes on the graphical user interface;
receive, via the graphical user interface, a second input that identifies a particular attribute from the one or more attributes; and
modify, based on the second input, the graphical user interface to display the initial ordering of the plurality of items such that the particular attribute is displayed or hidden for each item in the overview view.

13. The system of claim 12, wherein the at least one processor is configured, as part of automatically identifying the one or more attributes, to:
analyze the webpage with respect to a content dimension, a composition dimension, and a layout dimension, wherein:
the content dimension describes whether information is present in the overview view, the at least one detail view, or both,
the composition dimension describes how the overview view and the at least one detail view are connected together, and
the layout dimension describes a spatial arrangement of the overview view and the at least one detail view within the graphical user interface.

14. The system of claim 13, wherein the content dimension comprises at least one of a visual abstraction, a semantic abstraction, or a computational abstraction.

15. The system of claim 13, wherein the composition dimension comprises at least one of a one-to-one mapping, a many-to-one mapping, or a one-to-many mapping between the overview view and the at least one detail view.

16. The system of claim 13, wherein the layout dimension comprises at least one of an in-place spatial arrangement, an under-the-overview view spatial arrangement, or an above-the-overview view spatial arrangement, and wherein the overview view comprises a list view, a grid view, a table view, a timeline view, a map view, or a hierarchical structure of views.

17. A non-transitory computer-readable storage medium having instructions stored thereupon for interacting with a graphical user interface, comprising:
instructions for displaying, on the graphical user interface, a webpage comprising an overview view that corresponds to an initial ordering of a plurality of items and at least one detail view that corresponds to a selected item of the plurality of items, wherein each item comprises a plurality of attributes;
instructions for receiving, via the graphical user interface, a first input that toggles an attributes mode that enables modifying the graphical user interface;
instructions for automatically identifying, subsequent to receiving the first input, one or more attributes of the plurality of attributes on the graphical user interface;
instructions for receiving, via the graphical user interface, a second input that identifies a particular attribute from the one or more attributes; and
instructions for modifying, based on the second input, the graphical user interface to display the initial ordering of the plurality of items such that the particular attribute is displayed or hidden for each item in the overview view.

18. The non-transitory computer-readable storage medium of claim 17, wherein the overview view comprises a first ordering of the plurality of items based on an initial attribute, and wherein the instructions for modifying the graphical user interface comprise:
instructions for sorting, based on the particular attribute that is different from the initial attribute, the plurality of items to generate a second ordering of the plurality of items that is different from the first ordering of the plurality of items; and
instructions for displaying, via the graphical user interface, the second ordering of the plurality of items in the overview view.

19. The non-transitory computer-readable storage medium of claim 17, wherein the instructions for modifying the graphical user interface comprise:
instructions for sorting the plurality of items in an ascending order or a descending order of the particular attribute; and
instructions for displaying, within the overview view, a sorted plurality of items.

20. The non-transitory computer-readable storage medium of claim 17, further comprising:
instructions for filtering, based on the particular attribute and a threshold value associated with the particular attribute, the plurality of items to generate a filtered plurality of items, wherein each item on the filtered plurality of items is associated with the particular attribute being greater than or less than the threshold value; and
instructions for displaying, via the graphical user interface, the filtered plurality of items.
